(19) United States
(12) Patent Application Publication
(10) Pub. No.: US 2011/0078571 A1
(43) Pub. Date: Mar. 31, 2011

(54) PROVIDING VISUAL RESPONSES TO MUSICALLY SYNCHRONIZED TOUCH INPUT

(75) Inventors: Jason Lee Asbahr, Austin, TX (US); Heather Kay Dority, Austin, TX (US); Edward McNeely Robinson, Austin, TX (US)

(73) Assignee: Monstrous Company, Houston, TX (US)

(21) Appl. No.: 12/893,337

(22) Filed: Sep. 29, 2010

Related U.S. Application Data
(60) Provisional application No. 61/246,978, filed on Sep. 29, 2009.

(51) Int. Cl. G06F 3/01

(52) U.S. Cl. 715/716

(57) ABSTRACT

Methods, computer readable media, and apparatuses for providing visual responses to musically synchronized touch input are presented. A moving object may be displayed on a touch-sensitive display. Subsequently, a first display characteristic of the moving object may be changed synchronously with a beat of an audio track being played. Thereafter, in response to receiving user input corresponding to a tap on the moving object that is synchronized with the beat, the moving object may be altered in a first manner. In response to receiving user input corresponding to a tap on the moving object that is not synchronized with the beat, the moving object may be altered in a second manner different from the first manner. Optionally, a second display characteristic of the moving object may be changed to signal a user of the approaching beat prior to changing the first display characteristic of the moving object.

### CROSS-REFERENCE TO RELATED APPLICATIONS

This application claims the benefit of U.S. Provisional Patent Application Ser. No. 61/246,978, which was filed Sep. 29, 2009 and entitled “Interactive Visual Music Systems and Methods,” and which is incorporated by reference herein in its entirety.

### BACKGROUND

Aspects of this disclosure may relate to computer processing, multimedia computing, user interface design, and/or electronic/video games. In particular, aspects of the disclosure may relate to providing visual responses to musically synchronized touch input events in these and/or other various contexts.

In recent years, cellular phones, personal digital assistants, smart phones, and other mobile computing devices have become increasingly popular. Frequently, such devices provide various functionalities beyond telephony services, electronic mail services, and/or other communication functionalities. For example, it is becoming more common for such devices to include entertainment and/or electronic gaming functionalities. As these devices increasingly include such entertainment and/or electronic gaming functionalities, it may be desirable to provide more advanced, usable, and/or convenient user interfaces by which users of mobile computing devices may utilize such functionalities.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to providing visual responses to musically synchronized touch input. According to one or more aspects, a moving object may be displayed on a touch-sensitive display. Subsequently, a first display characteristic of the moving object may be changed synchronously with a beat of an audio track being played. Thereafter, in response to receiving user input corresponding to a tap on the moving object that is synchronized with the beat, the moving object may be altered in a first manner. Additionally or alternatively, in response to receiving user input corresponding to a tap on the moving object that is not synchronized with the beat, the moving object may be altered in a second manner different from the first manner. In at least one arrangement, a second display characteristic of the moving object may be changed to signal a user of the approaching beat prior to changing the first display characteristic of the moving object.

### BRIEF DESCRIPTION OF THE DRAWINGS

The present disclosure is illustrated by way of example and not limited in the accompanying drawings in which like reference numerals indicate similar elements and in which:

FIG. 1 illustrates an example computing device according to one or more aspects described herein.

FIG. 2 illustrates an example operating environment according to one or more aspects described herein.

FIG. 3 illustrates an example method of providing a visual response to musically synchronized touch input according to one or more aspects described herein.

FIGS. 4-12 illustrate example user interfaces by which a visual response to musically synchronized touch input may be provided according to one or more aspects described herein.

FIG. 13 illustrates an example schematic that includes one or more elements included in a scene according to one or more aspects described herein.

FIG. 14 illustrates an example series of glyph action states and action indicators according to one or more aspects described herein.

FIG. 15 illustrates an example listing of visual effects according to one or more aspects described herein.

FIG. 16 illustrates an example life form object according to one or more aspects described herein.

FIG. 17 illustrates an example user interface by which a user may select an audio track according to one or more aspects described herein.

FIG. 18 illustrates an example user interface including a plurality of glyphs and other objects in a scene according to one or more aspects described herein.

FIG. 19 illustrates an example listing of properties associated with a glyph according to one or more aspects described herein.

FIG. 20 illustrates an example arrangement of motion states and action states according to one or more aspects described herein.

FIG. 21 illustrates an example process of creating glyphs based on meta-data according to one or more aspects described herein.

FIG. 22 illustrates an example set of glyph paths according to one or more aspects described herein.

FIGS. 23-28 illustrate example modes in which one or more video game implementations of the disclosure may operate according to one or more aspects described herein.

FIG. 29 illustrates an example listing of properties defining a glyph according to one or more aspects described herein.

FIG. 30 illustrates an example pseudocode sequence that may be used in implementing various aspects of the disclosure according to one or more aspects described herein.

FIG. 31 illustrates an example method by which a game level may be generated according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It should be understood that other embodiments may be utilized, and structural and functional modifications may be made, without departing from the scope of the present disclosure.

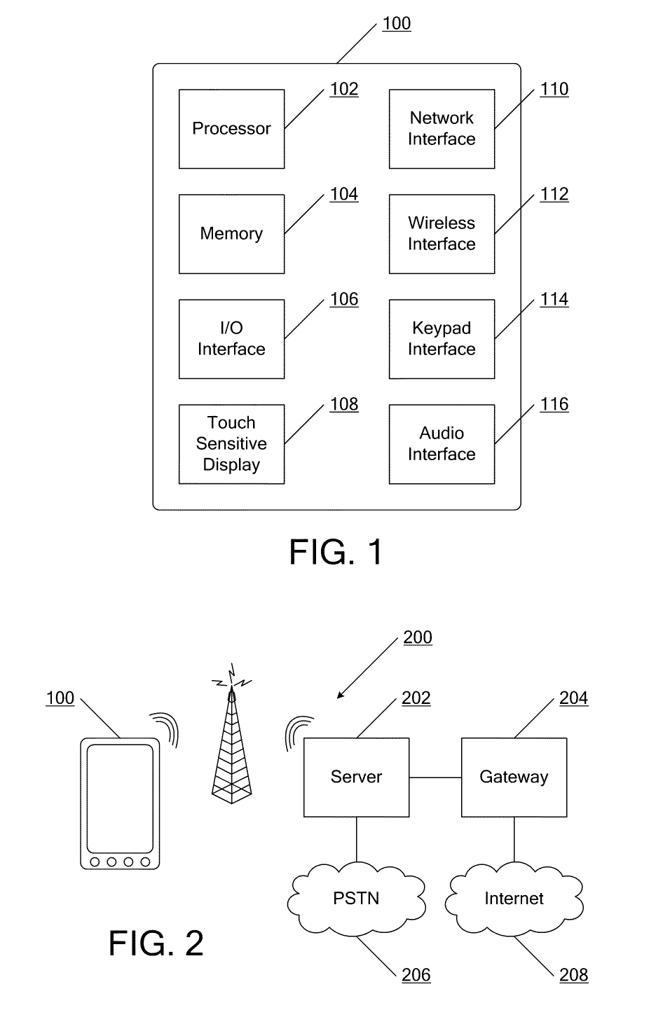

FIG. 1 illustrates an example computing device according to one or more aspects described herein. Computing device 100 may include one or more hardware and/or software components, such as processor 102, memory 104, input/output interface 106, touch-sensitive display 108, network interface 110, wireless interface 112, keypad interface 114, and audio interface 116. In one or more arrangements, computing device 100 may include a plurality of any and/or all of each of these components. For example, in at least one arrangement, computing device 100 may include two or more processors.

In at least one arrangement, processor 102 may execute computer-readable instructions that may be stored in memory 104, and this may cause computing device 100 to perform one or more functions. Input/output interface 106 may include one or more connection ports and/or other devices by which computing device 100 may provide input and output. For example, input/output interface 106 may include a display (e.g., for providing audiovisual, graphical, and/or textual output), keypad, microphone, mouse, camera, optical reader, scanner, speaker (e.g., for providing audio output), stylus, and/or touch screen. Input/output interface 106 further may include a USB port, serial port, parallel port, IEEE 1394/Firewire port, APPLE iPod Dock port, and/or other ports. In at least one arrangement, input/output interface 106 further may include one or more accelerometers and/or other motion sensors.

In one or more arrangements, touch-sensitive display 108 may comprise an electronic visual display (e.g., a liquid crystal display (“LCD”) screen, a plasma display panel (“PDP”), a cathode ray tube (“CRT”) display, a light emitting diode (“LED”) display, and/or an organic light emitting diode (“OLED”) display). Additionally or alternatively, touch-sensitive display 108 may implement one or more touch sensing technologies (e.g., resistive, surface acoustic wave, capacitive, strain gauge, optical imaging, dispersive signal technology, acoustic pulse recognition, coded LCD, etc.), and thus touch-sensitive display 108 may receive touch user input.

In at least one arrangement, network interface 110 may include one or more network interface cards configured to enable wired communications via Ethernet, TCP/IP, FTP, HTTP, HTTPS, and/or other protocols. Similarly, wireless interface 112 may include one or more network interface cards configured to enable wireless communications via Ethernet, TCP/IP, FTP, HTTP, HTTPS, IEEE 802.11b/g/a/n, Bluetooth, CDMA, TDMA, GSM and/or other protocols.

In one or more arrangements, keypad interface 114 may include one or more keys, buttons, and/or switches by which user input may be received by computing device 100. Audio interface 116 may include one or more speakers, audio ports (e.g., a headphone jack), microphones, and/or other audio components for providing audio input and/or audio output.

FIG. 2 illustrates an example operating environment according to one or more aspects described herein. Operating environment 200 may include server 202, which may communicate via one or more wired and/or wireless connections with computing device 100. Server 202 may be communicatively coupled to gateway 204 and public switched telephone network 206. Gateway 204 may interface with a network, such as the Internet 208. Thus, via one or more connections to server 202, computing device 100 may make and/or receive one or more telephone calls to and/or from one or more telephones connected to public switched telephone network 206. Additionally or alternatively, via one or more connections to server 202, computing device 100 may send and/or receive data to and/or from one or more computer networks, such as the Internet 208.

### I. Illustrative Embodiments

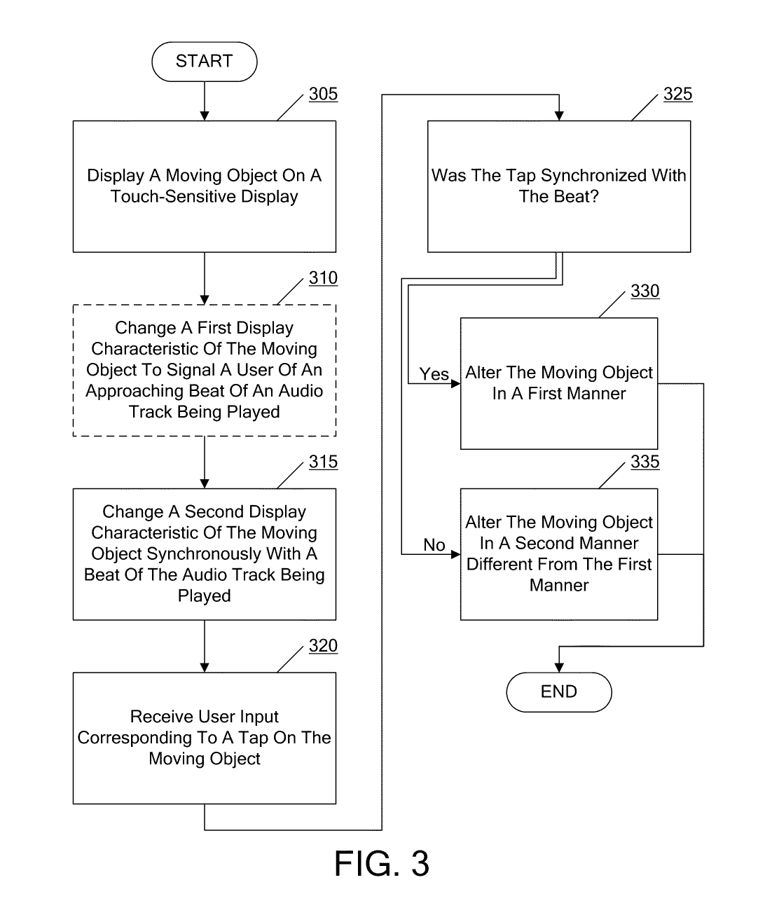

FIG. 3 illustrates an example method of providing a visual response to musically synchronized touch input according to one or more aspects described herein. According to one or more aspects, the methods described herein, such as the example method illustrated in FIG. 3, may be implemented in and/or performed by and/or in conjunction with a computing device, such as computing device 100.

In step 305, a first moving object may be displayed on a touch-sensitive display. In one or more arrangements, the first moving object may be moving along a non-linear path. For example, computing device 100 may display a glyph on touch-sensitive display 108, and computing device 100 may animate the glyph such that the glyph appears to move along a non-linear path. The glyph may be a two-dimensional shape (e.g., a square, a circle, a star, an outline, or any other two-dimensional shape) or a three-dimensional shape (e.g., a cube, a sphere, or any other three-dimensional shape). In one or more arrangements, the glyph may be a stylized and/or multicolor three-dimensional shape, such as a face, a skull, an animal, a fish, a plant, a planet, a star, and/or the like.

In optional step 310, a first display characteristic of the first moving object may be changed to signal a user of an approaching beat of an audio track being played. As used herein, a “beat” may include any discernable musical event in an audio track (e.g., a humanly discernable sound event that occurs once or repetitively in time with the tempo of an audio track being played, such as a guitar strum, drum hit, piano chord, sound effect, etc.). For example, to signal a user of an approaching beat, a second moving object may be rendered concentrically around the first moving object. In one or more arrangements, the second moving object may represent an outline of the first moving object. For instance, if the first moving object is a three-dimensional cube, the second moving object may be a three-dimensional outline (or a two-dimensional outline) of the three-dimensional cube. Additionally or alternatively, the second moving object may be rendered to shrink around the first moving object as the beat approaches. For example, as the beat approaches, the second moving object may shrink until it converges around the first moving object.

In at least one additional arrangement, the second moving object may be a different shape than the first moving object. For instance, if the first moving object is a three-dimensional cube, the second moving object may be a three-dimensional outline of a three-dimensional sphere. In another example, to signal a user of an approaching beat, one or more colors of the first moving object may be changed and/or one or more other display characteristics of the first moving object may be modified (e.g., the first moving object may flash and/or pulse in size with increasing frequency as the beat approaches).

In step 315, a second display characteristic of the first moving object may be changed synchronously with a beat of the audio track being played. For example, one or more colors of the first moving object may be changed, the first moving object may be rotated, the size of the first moving object may increase or decrease, and/or one or more other display characteristics of the first moving object may be modified (e.g., the first moving object may flash, pulse in size, etc.). In at least one arrangement, the first moving object may bulge in size and change color (e.g., from yellow or blue to red) synchronously with the beat of the audio track.

In step 320, user input may be received corresponding to a tap on the first moving object. For example, a user may tap on touch-sensitive display 108 at a point and/or area corresponding to the first moving object (e.g., a point and/or area where the first moving object is displayed on touch-sensitive display 108).

In step 325, it may be determined whether the tap was synchronized with the beat (of the currently playing song). For example, computing device 100 may analyze the user input corresponding to the tap and determine whether the tap was made within a predetermined time period corresponding to the beat. For instance, computing device 100 may determine that the tap was synchronized with the beat if the tap was made less than twenty milliseconds before the beat, on the beat, and/or less than twenty milliseconds after the beat. Of course, other time periods may be used. In at least one arrangement, these time periods may be reduced in order to increase a difficulty level (e.g., to increase the difficulty level, computing device 100 might only determine that the tap was synchronized with the beat if the tap was made less than five milliseconds before the beat, on the beat, and/or less than ten milliseconds after the beat). Additionally or alternatively, these time periods may vary with the tempo of the audio track being played. For instance, for an audio track with a relatively slower tempo, computing device 100 might determine that the tap was synchronized with the beat if the tap was made less than twenty milliseconds before the beat, on the beat, and/or less than twenty milliseconds after the beat. For an audio track with a relatively faster tempo, however, computing device 100 might only determine that the tap was synchronized with the beat if the tap was made less than five milliseconds before the beat, on the beat, and/or less than five milliseconds after the beat.

If it is determined that the tap was synchronized with the beat, then in step 330, the first moving object may be altered in a first manner. For example, if computing device 100 determines that the tap was synchronized with the beat, computing device 100 may display a blooming object on touch-sensitive display 108 in place of the first moving object. In at least one arrangement, the blooming object may include a plurality of moving objects, and each of the plurality of moving objects may grow in size over time. For instance, the blooming object may include one or more stars, confetti strips, cubes, spheres, and/or other glyphs and/or objects. Additionally or alternatively, in this example, as time elapses from the tap and/or the beat, each of the plurality of moving objects may grow in size and/or rotate, and subsequently each of the plurality of moving objects may be gradually removed from the display (e.g., by fading out, by moving out of the display, etc.).

On the other hand, if it is determined that the tap was not synchronized with the beat, then in step 335, the first moving object may be altered in a second manner different from the first manner. For example, if computing device 100 determines that the tap was not synchronized with the beat, computing device 100 may change the color of the first moving object, change the size of the first moving object, and/or remove the first moving object from the display. In at least one arrangement, if computing device 100 determines that the tap was not synchronized with the beat, then computing device 100 may darken the first moving object, decrease the size of the first moving object, and/or remove the first moving object from the display.

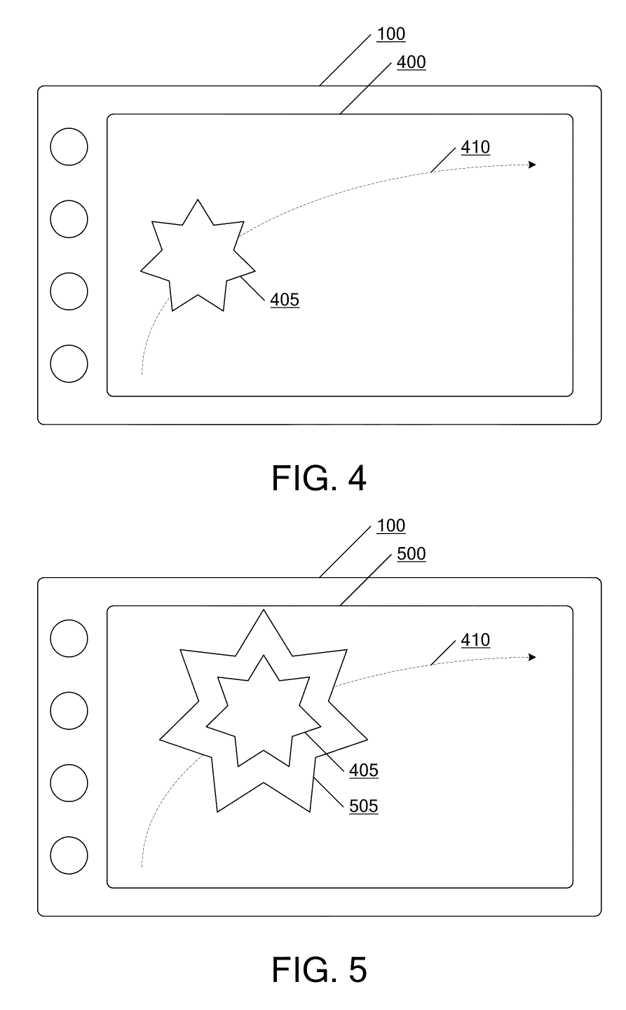

FIGS. 4-12 illustrate example user interfaces by which a visual response to musically synchronized touch input may be provided according to one or more aspects described herein. According to one or more aspects, the user interfaces described herein, such as the user interfaces illustrated in FIGS. 4-12, may be implemented in, displayed by, and/or used in conjunction with a computing device, such as computing device 100.

As illustrated in FIG. 4, a computing device, such as computing device 100, may display user interface 400. User interface 400 may include a moving object, such as moving object 405, moving along a non-linear path, such as path 410. As discussed above, the moving object may be, for example, a two-dimensional shape (e.g., a square, a circle, a star, an outline, or any other two-dimensional shape) or a three-dimensional shape (e.g., a cube, a sphere, or any other three-dimensional shape). In addition, in one or more arrangements, the moving object may be a stylized and/or multicolor three-dimensional shape, such as a face, a skull, an animal, a fish, a plant, a planet, a star, and/or the like.

As illustrated in FIG. 5, a computing device, such as computing device 100, may display user interface 500. In user interface 500, moving object 405 may have moved further along path 410. In addition, user interface 500 may include moving object 505. As seen in FIG. 5, moving object 505 may be rendered concentrically around moving object 405, and thus, moving object 505 may signal a user of an approaching beat of an audio track being played, as described above.

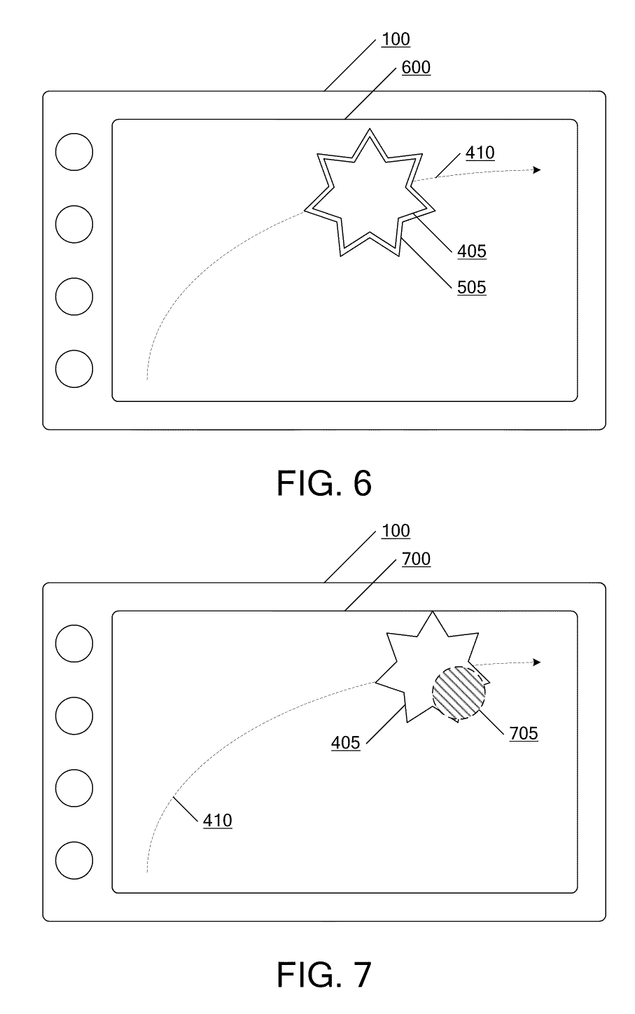

As illustrated in FIG. 6, a computing device, such as computing device 100, may display user interface 600. In user interface 600, moving object 405 and moving object 505 may have moved further along path 410. In addition, moving object 505 may have shrunk around moving object 405, and this shrinking may signal a user of an approaching beat of an audio track being played, as described above. Additionally or alternatively, this shrinking may indicate that the approaching beat of the audio track is closer in FIG. 6 than it was in FIG. 5.

As illustrated in FIG. 7, a computing device, such as computing device 100, may display user interface 700. In user interface 700, moving object 405 may have moved further along path 410, and moving object 505 (seen in FIGS. 5 and 6) may have completely converged around moving object 405, such that moving object 505 is no longer displayed. As discussed above, the shrinking of moving object 505 may have signaled an approaching beat of an audio track being played, and the convergence of moving object 505 and moving object 405 in user interface 700 may indicate that the beat of the audio track has arrived. Additionally or alternatively, one or more other display characteristics of moving object 405 may be changed synchronously with the beat of the audio track (e.g., moving object 405 may grow or shrink in size, rotate, change colors, flash in color, pulse in size, etc.).

According to one or more aspects, touch point 705 in FIG. 7 may represent a point where a user of computing device 100 has tapped on a touch-sensitive display included in computing device 100 (e.g., touch-sensitive display 108). As described above, computing device 100 may perform different actions depending on whether the user's tap was synchronized with the beat of the audio track.

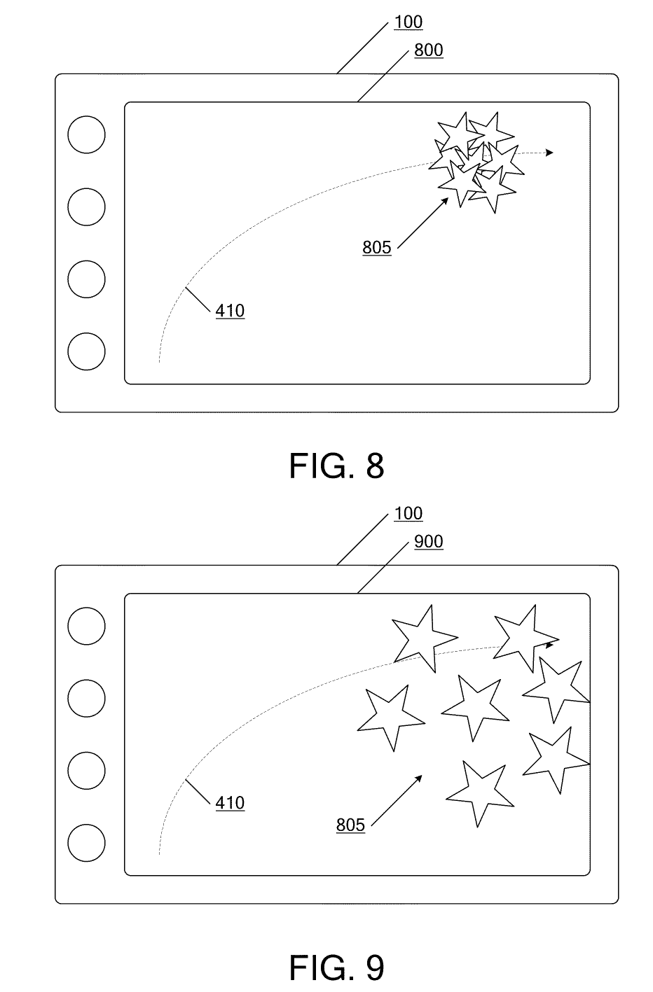

In one or more arrangements, a computing device, such as computing device 100, may display user interface 800 (as illustrated in FIG. 8) in response to determining that the tap corresponding to touch point 705 was synchronized with the beat of the audio track being played. As described above, in at least one arrangement, if computing device 100 determines that the tap was synchronized with the beat, computing device 100 may display a blooming object in place of the moving object. Thus, user interface 800 may include blooming object 805, which may include a plurality of moving objects (e.g., a plurality of shooting stars) and which may take the place of moving object 405. Additionally or alternatively, as time elapses from the beat, each of the plurality of moving objects included in blooming object 805 may grow in size, rotate, and/or otherwise change, as may be seen in user interface 900 of FIG. 9.

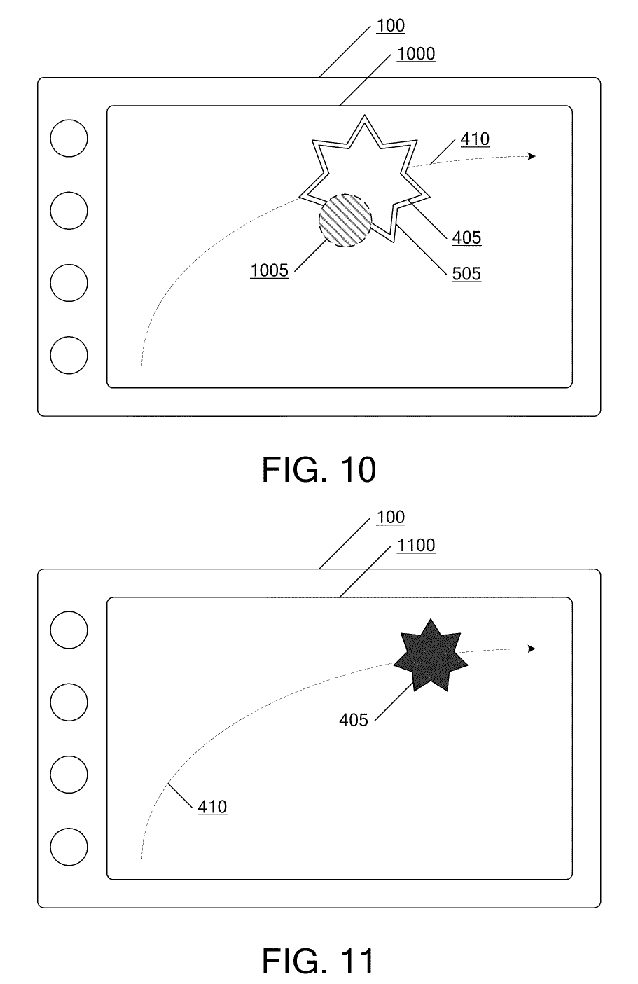

In one or more additional arrangements, a computing device, such as computing device 100, may display user interface 1000, which is illustrated in FIG. 10. In at least one arrangement, user interface 1000 may be displayed after user interface 600 of FIG. 6 is displayed. In user interface 1000, moving object 505 may be shrinking around moving object 405 to signal a user of an approaching beat of an audio track being played, but as moving object 505 has not yet converged around moving object 405, the beat might not have arrived yet.

According to one or more aspects, touch point 1005 may represent a point where a user of computing device 100 has tapped on a touch-sensitive display included in computing device 100 (e.g., touch-sensitive display 108). In contrast to the example described above with respect to FIG. 7, in FIG. 10, a user may have tapped on moving object 405 prior to the convergence of moving object 505 around moving object 405. Thus, in this example, the user's tap might not have been synchronized with the beat of the audio track.

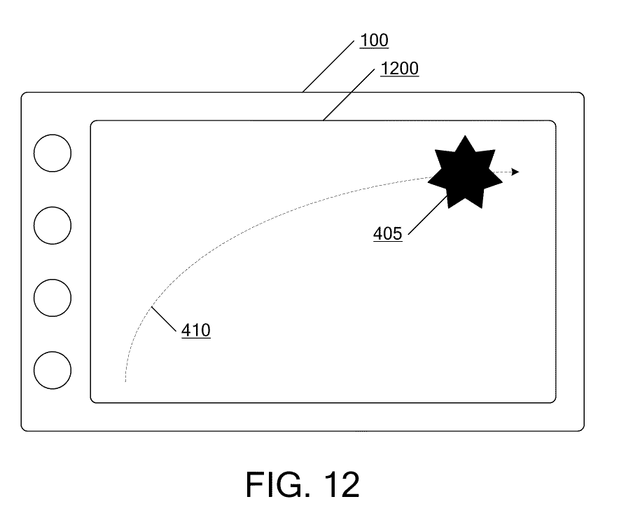

In one or more arrangements, a computing device, such as computing device 100, may display user interface 1100 (as illustrated in FIG. 11) in response to determining that the tap corresponding to touch point 1005 was not synchronized with the beat of the audio track being played. As described above, in at least one arrangement, if computing device 100 determines that the tap was not synchronized with the beat, computing device 100 may change the color of moving object 405, change the size of moving object 405, and/or remove moving object 405 from the display. Thus, in user interface 1100, moving object 405 may be reduced in size, darkened in color, and moving towards the edge of the display. Additionally or alternatively, as time elapses from the beat, moving object 405 may continue to shrink in size, darken in color, and/or disappear from the display, as may be seen in user interface 1200 of FIG. 12.

While one or more of the examples above may generally describe one object concentrically shrinking around another object to signal a user of an approaching beat, other images, animations, actions, and/or details could be similarly used to signal a user of an approaching beat. Indeed, it is contemplated that, in a system implementing one or more aspects of the disclosure, any discernable visual detail displayed by the system may be used to anticipatorily signal a user of an upcoming need for user action. For example, the system may generate a scene based on meta-data associated with an audio track (as further described below), and the meta-data may dictate that the system generate a particular visual detail or effect (e.g., movement of a character in the scene) that anticipatorily signals the user of an upcoming user action that is necessary to advancement in the game. In one example involving anticipatory signaling further described below, such a visual effect may include a character in a scene drawing back his sword to anticipatorily signal the user of an approaching need for user action and the character forwardly swinging his sword to prompt the user to act. Furthermore, in this example, the character's forward swinging of his sword may be synchronized with a beat in an associated audio track. In this way, the anticipatory signal and/or the prompt for user action may be tied to and/or synchronized with aspects of the associated audio track.

### II. Additional Illustrative Embodiments

As described above, one or more aspects of the disclosure may be implemented in the form of a video game. In one or more arrangements, a system implementing one or more aspects of the disclosure may generate game levels and/or other discrete content for game play. In at least one arrangement, the system may generate a game level based on an audio track and other information, as further described below.

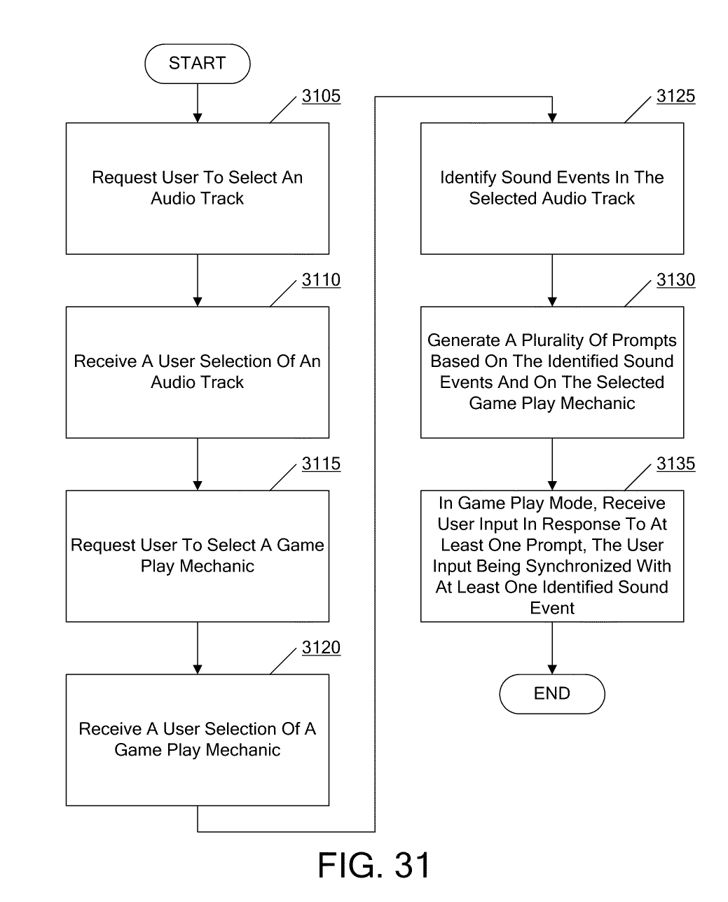

FIG. 31 illustrates an example method by which a game level may be generated according to one or more aspects described herein. According to one or more aspects, the methods described herein, such as the example method illustrated in FIG. 31, may be implemented in and/or performed by and/or in conjunction with a computing device, such as computing device 100.

In step 3105, a user may be requested to select an audio track. For example, a system implementing one or more aspects of the disclosure (e.g., computing device 100) may display a user interface (e.g., a dialog box, menu, etc.) to a user requesting the user to select an audio track from a listing of audio tracks. As further discussed below, the audio track selected by the user in step 3105 may, for instance, be used by the system in generating a game level. Additionally or alternatively, the system may select an audio track (e.g., randomly or according to a default setting) instead of requesting the user to do so.

In step 3110, a user selection of an audio track may be received. For example, after requesting the user to select an audio track, such a selection may be received by the system.

In step 3115, a user may be requested to select a game play mechanic. For example, the system may display a user interface, such as a dialog box or menu, to a user that requests the user to select a game play mechanic from a listing of game play mechanics. As further discussed below, the game play mechanic selected by the user in step 3115 may, for instance, be used by the system in generating a game level. Additionally or alternatively, the system may select a game play mechanic (e.g., randomly or according to a default setting) instead of requesting the user to do so. In at least one additional arrangement, the system may be preconfigured to implement a certain game mechanic (e.g., a fighting game mechanic or a driving game mechanic may be preselected) and the user might, for example, not have an option to choose or change the preconfigured game mechanic. Similarly, in another additional arrangement, a particular audio track may be associated with a particular game mechanic (e.g., one particular song might only be implemented with a fighting game mechanic) and the user might, for example, not have an option to choose or change the game mechanic with respect to the particular audio track.

In one or more arrangements, one possible game play mechanic that the user may select is a side scroller game play mechanic. In a side scroller game play mechanic, the user may be represented by an avatar or other user representation in the game that can be moved laterally (and possibly vertically) through a game level. As the user's avatar moves through the game level, it may encounter obstacles that need to be avoided (e.g., pits, walls, etc.) and/or enemies that need to be defeated (e.g., monsters, aliens, etc.). According to one or more aspects, the obstacles and/or enemies in a side scroller game play mechanic may represent prompts, as further described below, that require a user to provide user input or otherwise act synchronously with one or more sound events of an audio track. For instance, a game level may be generated based on an audio track and a side scroller game play mechanic, and the game level may include obstacles and/or enemies at certain points in the game level that correspond to sound events in the audio track. In at least one arrangement, the sequence of obstacles and/or enemies in the game level may establish a rhythm aligned with the audio track because, for instance, the user's avatar may move through the game level at a constant speed. In at least one additional arrangement, the tempo of the audio track may be increased, decreased, and/or otherwise modified such that the tempo is synchronized with the movement of the user's avatar through the game level. If, for example, the user fails to avoid one or more obstacles and/or defeat one or more enemies in response to and/or in time with one or more prompts, the user may lose points while in a game play mode and/or the game level may end.

In one or more additional arrangements, a user may select a fighting game play mechanic. In a fighting game play mechanic, the user may be represented by an avatar or other user representation in the game that can move around a two-dimensional or three-dimensional area in a game level in which one or more enemies around encountered. In the game level, the user's avatar may need to perform physical, magical, and other attacks to defeat the one or more enemies included in the game level. According to one or more aspects, in a fighting game play mechanic, the enemies may perform attacks on the user's avatar synchronously with sound events in the audio track, and these attacks may represent prompts that require the user to provide user input or otherwise act synchronously with the sound events. For instance, the user may need to defend from the attacks in time with the sound events (e.g., by inputting commands that cause the user's avatar to block the attacks). Additionally or alternatively, the user may need to perform attacks on the enemies synchronously with sound events in the audio track. Whether the user is defending attacks or performing attacks, the user may, for example, be required to act synchronously with the sound events based on prompts in the game level, and the sequence of such prompts may establish a rhythm aligned with the audio track. If, for example, the user fails to defend one or more attacks and/or perform one or more attacks in response to and/or in time with one or more prompts, the user may lose points while in a game play mode and/or the game level may end.

In another example involving a fighting game play mechanic, movement of a character (e.g., an enemy character) may be used to anticipatorily signal the user of an approaching beat in an associated audio track and a corresponding approaching need for user action (e.g., the need for the user to defend his or her avatar from an attack about to be launched by the enemy character). Additionally or alternatively, movement of the character (e.g., the enemy character) may be used to prompt the user to provide user input and/or otherwise act. For example, the enemy character may be carrying a sword, and as a beat approaches, the enemy character may draw back his sword. In this situation, the enemy character's drawing back of his sword may signal the user of the approaching beat and/or an approaching prompt associated with the beat. In addition, continuing this example, when the beat arrives, the enemy character may swing his sword forward, thus prompting the user to act. In particular, in this example, when the beat arrives and the enemy character swings his sword forward, the visual animation may function to prompt the user to provide user input causing the user's avatar to defend against the enemy character's attack. Thus, in this example, both the animation forming the anticipatory signal and the animation forming the prompt may be in time with the music of the associated audio track and/or may be defined and/or synchronized by meta-data associated with the audio track, as further described below.

In at least one additional arrangement, a user may select a racing game play mechanic. In a racing game play mechanic, the user may be represented by an avatar (e.g., a driver) or other representation (e.g., an automobile) in a game level, and the user may accelerate, brake, and steer a vehicle along a track or other path in the game level. As the user navigates the vehicle through the game level, the user may encounter one or more obstacles that need to be avoided (e.g., fences, turns, railings, pedestrians, other vehicles, etc.). According to one or more aspects, these obstacles may represent prompts that require a user to provide user input or otherwise act synchronously with the sound events of the audio track. For instance, the user may need to swerve around a pole on the race track, and the pole may appear in time with (or slightly in advance of) a sound event, such that the pole prompts the user to swerve and such that the swerve is synchronized with the sound event. Thus, in one or more arrangements, the sequence of obstacles in the game level may establish a rhythm aligned with the audio track. Additionally or alternatively, the tempo of the audio track may be increased, decreased, and/or otherwise modified such that the tempo is synchronized with the movement of the user's avatar and/or vehicle through the game level. If, for example, the user fails to avoid one or more obstacles in response to and/or in time with one or more prompts, the user may lose points while in a game play mode and/or the game level may end.

In at least one additional arrangement, a user may select an exercise game play mechanic. In an exercise game play mechanic, the user may be represented by an avatar or other representation in the game, and the user's avatar may mimic actual movements physically made by the user. For instance, the user may wear one or more motion sensors, accelerometers, and/or the like, and the system may detect the user's physical movements. Additionally or alternatively, the system may include one or more cameras and/or other visual detectors that may provide video input to the system, and the system may analyze the video input to determine the user's physical movements. According to one or more aspects, the system may present the user with one or more physical challenges and/or exercises to be performed (e.g., yoga poses, jumping jacks, etc.), and the system may monitor the user's performance using various sensors. In addition, the physical challenges and/or exercises presented to the user may represent prompts that require the user to act synchronously with one or more sound events of an audio track. For instance, a game level generated based on an exercise game play mechanic may request the user to performing jumping jacks and push ups in time with sound events in audio track. In this way, the sequence of prompts may establish a rhythm aligned with the audio track. If, for example, the user fails to perform one or more physical challenges and/or exercises in response to and/or in time with one or more prompts, the user may lose points while in a game play mode and/or the game level may end.

Referring again to FIG. 31, in step 3120, a user selection of a game play mechanic may be received. For example, after requesting the user to select a game play mechanic, the user may select one of the game play mechanics described above, and such a selection may be received by the system.

In step 3125, one or more sound events in the selected audio track may be identified. For example, the system may analyze the audio track to identify events such as beats, movements, tempo changes, and/or the like. The system may identify such events using waveform analysis (e.g., by determining that peaks in the waveform are sound events), Fast Fourier Transform analysis (e.g., by determining that frequencies with the highest amplitudes are sound events), and/or other methods.

In step 3130, a plurality of prompts may be generated based on the identified sound events and based on the selected game play mechanic. For example, depending on the selected game play mechanic the system may generate a plurality of prompts where each prompt corresponds to an identified sound event, and collectively, the plurality of prompts may represent a game level. As described above, the system thus may, for instance, generate a game level that implements a side scroller game play mechanic, a fighting game play mechanic, a racing game play mechanic, an exercise game play mechanic, or another game play mechanic.

In step 3135, user input may be received in response to at least one prompt while in a game play mode. In addition, the user input may be synchronized with at least one identified sound event. For example, during a game play mode, the system may receive user input in response to one or more prompts included in a game level. Where, for instance, the user input is properly synchronized with one or more sound events in an associated audio track, the system may reward the user, as described elsewhere herein (e.g., by displaying a blooming object, awarding points to the user, etc.). On the other hand, where, for instance, the user input is not properly synchronized with one or more sound events in the associated audio track, the system might not reward the user and/or may penalize the user (e.g., by subtracting points from the user's score, by ending the game level, etc.).

### III. Additional Aspects

As described above, one or more aspects of the disclosure may be implemented in the form of a video game. In one or more arrangements, various aspects of the disclosure also may be implemented in creating a multi-sensory feedback loop. For example, computing device 100 may receive touch user input and provide one or more visual, auditory, tactile (e.g., vibratory), and/or other responses. By playing an audio track that includes one or more beats and displaying one or more artistic visual indicators on a display screen, a computing device, such as computing device 100, may allow a user to become immersed in and/or entranced by the audio track and the associated visual indicators. Moreover, as the user listens to the various beats of the audio track and views the visual indicators displayed by computing device 100, the user may react and provide user input to computing device 100 in the form of taps and/or other touch user input, such as tilts, shakes, and/or other motion user input, which may be detected by one or more accelerometers, magnetometers, and/or other motion sensors included in computing device 100. For instance, a user may tilt computing device 100, and via one or more accelerometers that may be included in computing device 100, computing device 100 may detect the tilt as user input and provide a visual response (e.g., computing device 100 may display a tilted shape or simulate a gravitational response, such as objects sliding in the direction of the tilt, on touch-sensitive display 108). In at least one arrangement, computing device 100 may use one or more motion sensors to detect whole body movement and/or process such movement as user input.

According to one or more aspects, the difficulty level of one or more video game components of the disclosure may vary with the ability of a user to match and/or synchronize one or more beats included in an audio track and one or more visual indicators with touch user input (e.g., taps, slides, etc.). For example, where a user is relatively successful in synchronizing touch input with one or more audio and/or visual cues, computing device 100 may increase the tempo of the audio track to increase the difficulty level of the video game. On the other hand, where a user is relatively unsuccessful in synchronizing touch input with one or more audio and/or visual cues, computing device 100 may decrease the tempo of the audio track to decrease the difficulty level of the video game.

Additionally or alternatively, computing device 100 may alter various properties of one or more displayed objects to provide various indications to a user. For instance, computing device 100 may alter the shape, size, texture, color, and/or lifespan (e.g., the length of time an object is displayed) of one or more objects to anticipatorily signal to a user that a beat is approaching in an audio track being played. In one or more arrangements, such alteration may implement generative graphics techniques and/or life-like animation. In this manner, computing device 100 may directly indicate to a user that an input action is and/or will be required to advance one or more aspects of the video game.

By implementing one or more aspects of the disclosure, computing device 100 may enable a user to attain a state of “flow” in which the user is fully immersed in the gaming experience while simultaneously feeling energized, involved, and successful. In one or more arrangements, computing device 100 may cultivate such a state in a user by providing clear goals, a limited field of attention upon which the user may concentrate to a high degree, a merging of action and awareness, direct and/or immediate feedback (e.g., in the form of audio response, visual response, and/or tactile response), a balancing of ability level and difficulty level, a sense of control over the activity, and/or rewarding visual feedback for desired activities.

In one or more arrangements, a software implementation of one or more video game aspects described herein may include various components, such as a music player, a glyph manager, an environment manager, and/or a network manager. In at least one arrangement, the music player may start and stop playing one or more audio tracks, repeat particular sections of the one or more audio tracks, increase and/or decrease the speed of particular sections of the one or more audio tracks, and/or switch between different sections of the one or more audio tracks and/or different audio tracks. In addition, in at least one arrangement, the glyph manager may generate one or more glyphs (e.g., one or more moving objects to be displayed by computing device 100) based on event information and/or meta-data associated with one or more audio tracks. For example, the glyph manager may generate and/or render one or more glyphs according to instructions that specify one or more action states, motion states, and/or special effects associated with one or more audio tracks, as further discussed below.

Furthermore, in one or more arrangements, the environment manager may manage and process changes in user perspective, game-play mechanics (e.g., first person perspective, side scrolling perspective, racing perspective, etc.), and/or environment variables (e.g., background elements, progress display indicators, etc.). Additionally or alternatively, the environment manager may set and/or modify various environmental variables based on user interaction (e.g., different environmental conditions may be associated with successful synchronization of touch input with one or more beats than with unsuccessful synchronization). In addition, in at least one arrangement, the network manager may manage and/or process the downloading of music and/or meta-data from one or more remote servers; the uploading of user scores, achievements, and/or other data to one or more remote servers; and/or the transmitting and/or receiving of multiplayer data between one or more computing devices and/or servers. In at least one arrangement, the network manager may also encrypt one or more encryption standards (e.g., secure sockets layer encryption) to enhance privacy and/or information security.

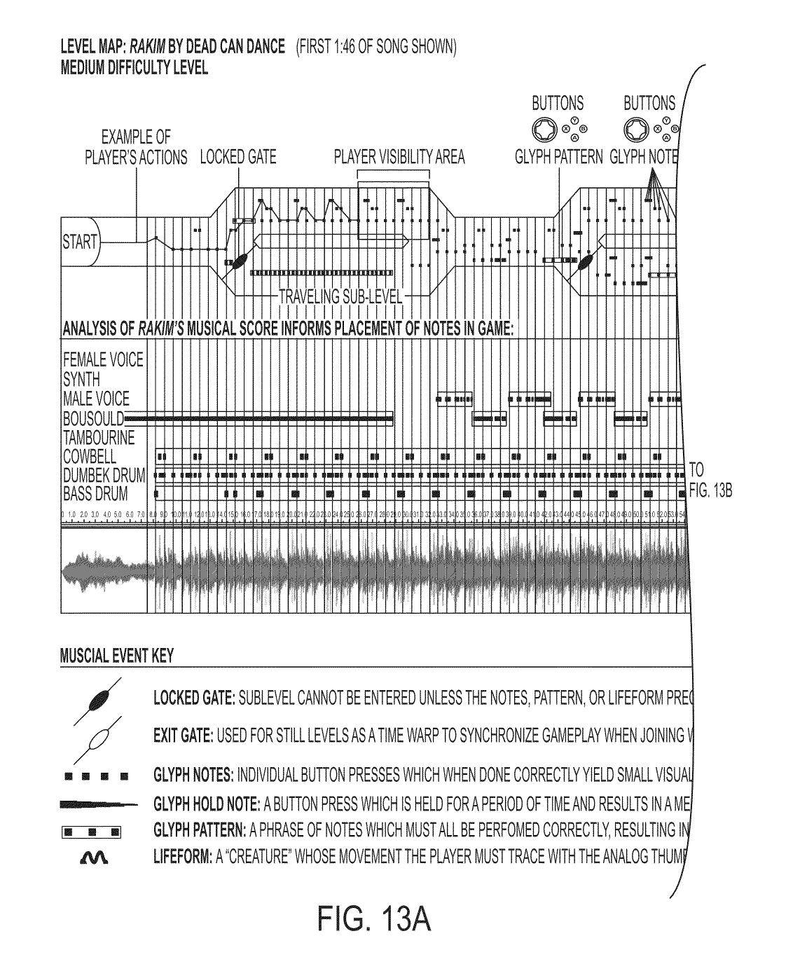

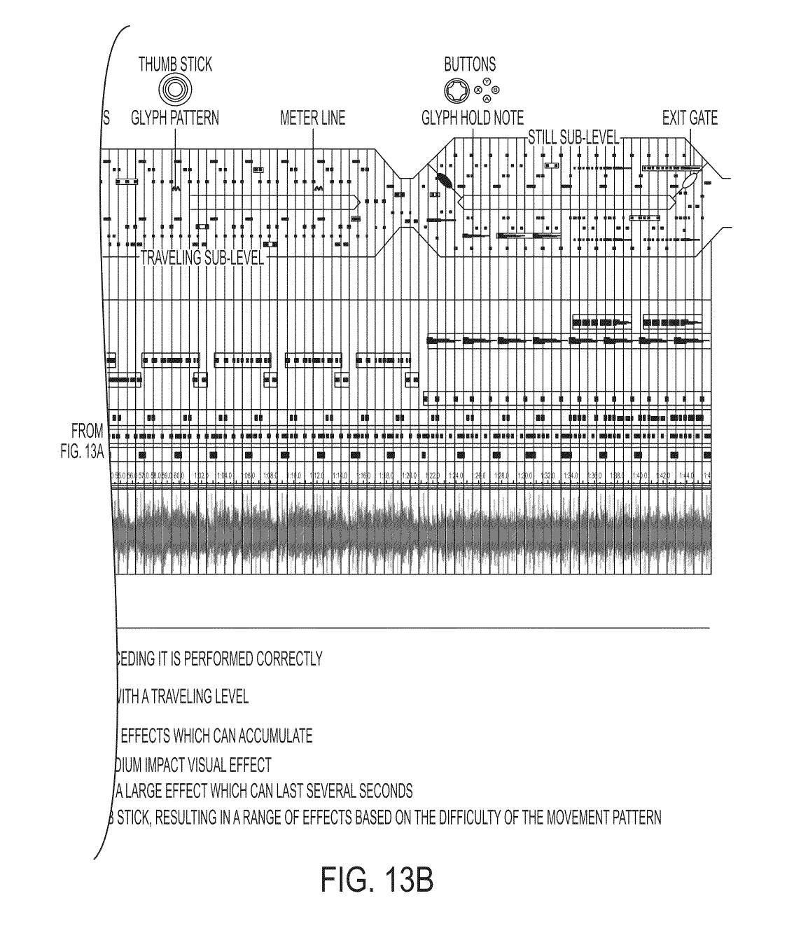

According to one or more aspects, a video game implementation of one or more aspects of the disclosure may include one or more scenes. FIG. 13 illustrates an example schematic that includes one or more elements included in a scene according to one or more aspects described herein.

In one or more arrangements, a scene may include an associated environment and at least one associated audio track. In one or arrangements, the environment may include a three-dimensional space that includes one or more interactive objects, such as viewpoint cameras, gates, glyphs, life forms, blooms, and/or background elements, as further described elsewhere herein. Additionally or alternatively, each scene may be directed by meta-data corresponding to the at least one audio track associated with the particular scene. In one or more arrangements, the meta-data may include information about events in and characteristics of the at least one audio track that may influence one or more visual aspects of the scene. In one or more arrangements, each scene may further be directed by a dynamic adaptation algorithm (which is further described below) and/or by user input. Additionally or alternatively, the length of a particular scene may depend on the length of the at least one audio track associated with the particular scene.

In one or more arrangements, computing device 100 may display a user's viewpoint as moving through a scene in time with an audio track. Additionally or alternatively, computing device 100 may display to a user one or more gates during the displaying of a scene. Gates may allow a user to access different levels and/or sub-levels of game play, and gates may appear in the form of a doorway materializing and/or opening, a black hole materializing, a cave entrance appearing near a corner of the display, a signpost moving onto the display screen, and/or the like. In at least one arrangement, gates may be displayed as a reward for correct game play during a scene and/or associated audio track. In at least one alternative arrangement, a gate may be disguised to add complexity to game play and/or be displayed before a dramatic movement in an audio track.

According to one or more aspects, a sub-level may be an alternative scene associated with a particular audio track. A sub-level may occur when there is a significant change in the intensity of an audio track associated with a scene and/or when the pace or tempo of the audio track changes significantly and/or for an extended duration. In at least one arrangement, a sub-level may include a different environment than the previous scene leading into the sub-level, a different audio track than the previous audio track leading into the sub-level, and/or a different note pattern than the previous scene. In some instances, the different audio track may be complementary to the previous audio track (e.g., in the same musical key, at the same tempo, etc.). When a sub-level is displayed to a user, computing device 100 may seamlessly transition between the different audio, visual, and/or tactile elements of the scene being exited and the sub-level being entered. In addition, at the end of the sub-level, computing device 100 may once again transfer the user back to the original scene. Additionally or alternatively, the user may be provided with an option to repeat the sub-level at the end of the sub-level. At the end of the original scene, an exit gate may be displayed, and the exit gate may allow the user to leave the scene.

According to one or more aspects, glyphs may be two-dimensional or three-dimensional objects that may move on and off the display along one or more two-dimensional or three-dimensional paths. Glyphs may function as visual interaction indicators that cue a user of an action to be taken. Additionally or alternatively, glyphs may appear as notes, note patterns, or life forms.

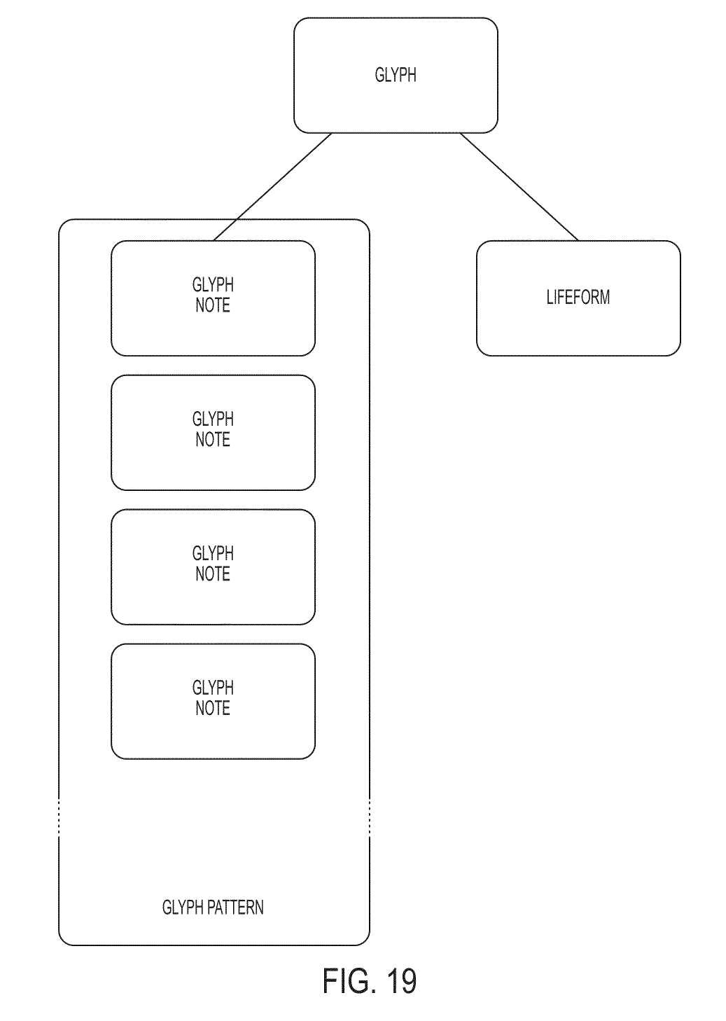

FIG. 19 illustrates an example listing of properties associated with a glyph according to one or more aspects described herein. In addition, FIG. 29 illustrates an example listing of properties defining a glyph according to one or more aspects described herein. In one or more arrangements, a glyph may be defined by various properties, such as shape, size, texture, color, and lifespan. These properties may vary on the environment of a particular scene and/or aspects of an audio track associated with the scene and/or with one or more glyphs.

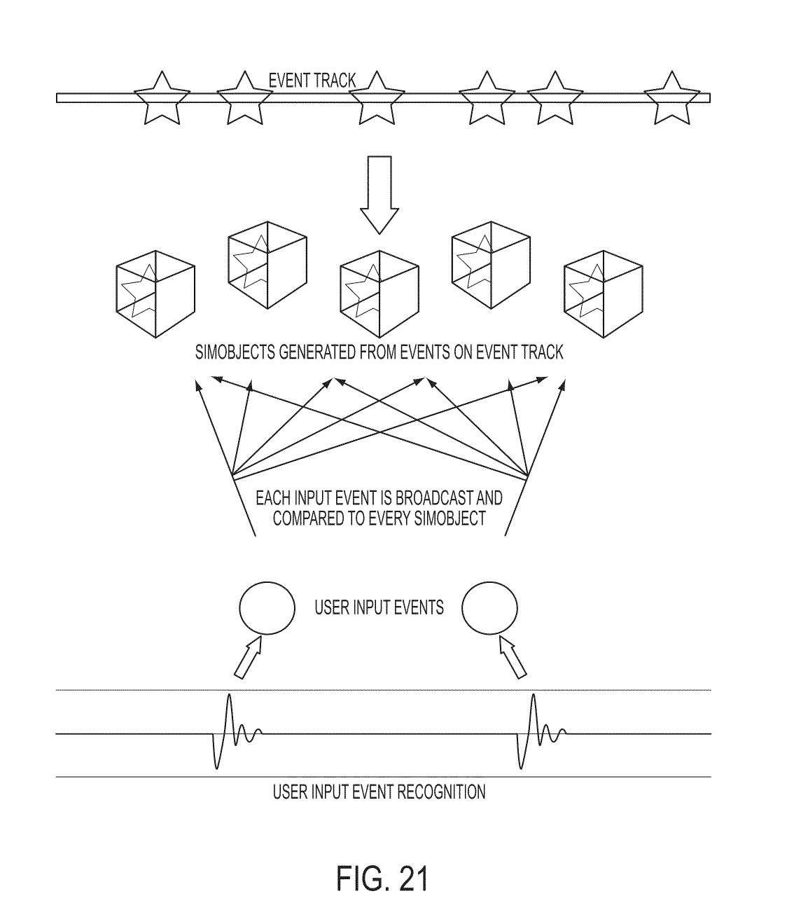

In at least one arrangement, glyphs may be defined as and/or by objects in computer programming code, and the visual appearance and/or actions of glyphs may be directed by meta-data associated with an audio track, current environment variables, and/or user input. FIG. 21 illustrates an example process of creating glyphs based on meta-data according to one or more aspects described herein. In one or more arrangements, meta-data may include information to synchronize the actions of one or more glyphs with one or more beats of at least one audio track. In one or more arrangements, the meta-data may define one or more events, which may describe a feature or beat in a particular audio track and/or may correspond to user input expected to be received at a particular time (e.g., a tap expected to be received in synchronization with a beat). In addition, different events may be associated with different types of expected user input (e.g., input received via a control pad button, input received via an accelerometer, etc.). In at least one arrangement, events corresponding to a particular audio track may be stored in an event track that guides player interaction during game play. A plurality of event tracks may be included in meta-data, and different event tracks may correspond to different difficulty levels, object paths, and/or looping sequences.

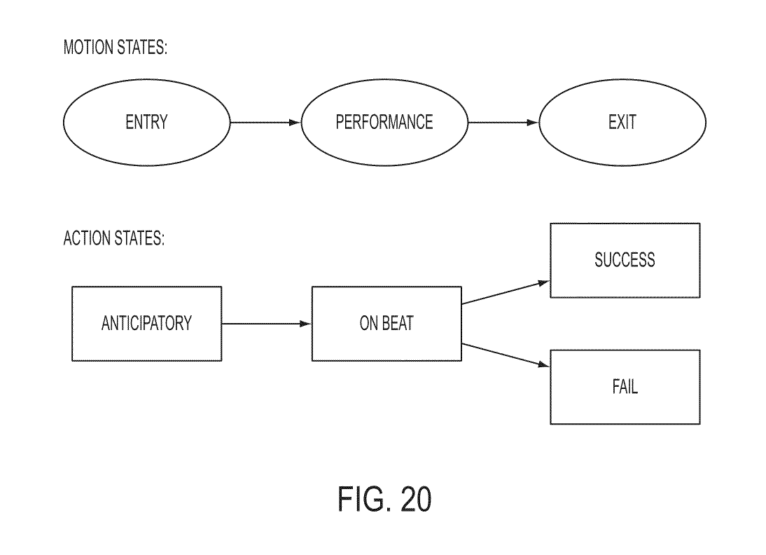

According to one or more aspects, a glyph may be associated with one or more motion states, which may define the movement and/or path of a particular glyph. FIG. 20 illustrates an example arrangement of motion states and action states according to one or more aspects described herein. In at least one arrangement, the spin forces, movement vectors, magnetism and/or gravity effects, and/or other motion properties of a glyph may depend on and/or be determined based on events included in an animation library and/or the success of a user in synchronizing user input with one or more beats in an audio track being played. Additionally or alternatively, meta-data may cause the shape of a glyph to change over time (e.g., to correspond to a particular audio track being played).

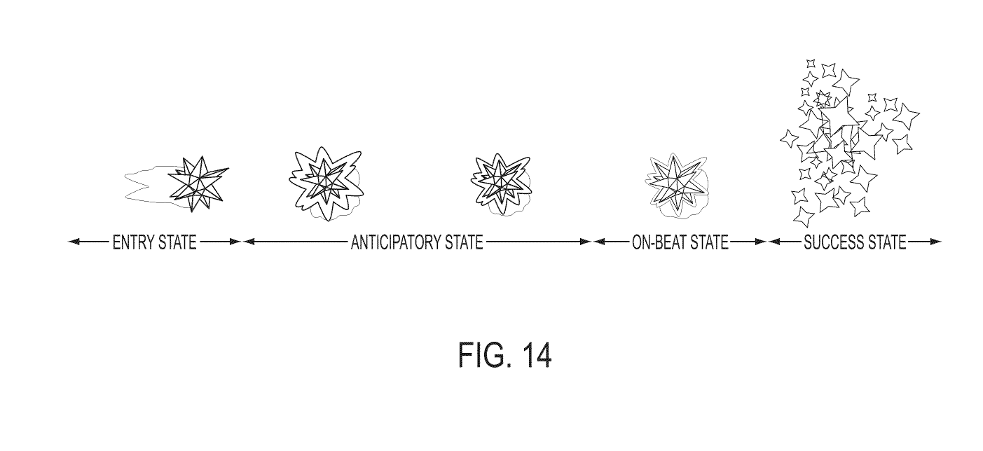

FIG. 14 illustrates an example series of glyph action states and action indicators according to one or more aspects described herein. In one or more arrangements, example motion states for a glyph may include an entry state, a performance state, and an exit state. An entry state for a glyph may include instructions defining how the glyph enters the environment and/or the display, and such instructions may specify an entry location and/or one or more visual effects. A performance state for a glyph may include instructions defining one or more actions of the glyph while in the environment, and such instructions may specify one or more paths for the glyph and/or one or more visual effects. In one or more arrangements, the paths of one or more glyphs may be defined automatically by an algorithm and/or a path generator, or such paths may be imported from an animation tool and/or motion capture software. An exit state for a glyph may include instructions defining how the glyph exits the environment and/or the display, and such instructions may specify an exit location and/or one or more visual effects.

According to one or more additional aspects, a glyph may be associated with one or more action states, which may define how a particular glyph interacts with an environment and/or with a user. In one or more arrangements, example action states for a glyph may include an anticipatory state, an on-beat state, a success state, and a failure state. An anticipatory state may include instructions defining one or more visual changes to be made to a glyph as a beat in an audio track being played approaches. Such visual changes may include, for example, a change in size, a change in color, the addition of a color, a concentric shape (e.g., a halo, an outline of a star, etc.) around the glyph that expands and/or shrinks, an animation or other visual effect (e.g., an attack animation synchronized with one or more aspects of an audio track, such as a character drawing a sword back and/or swinging a sword forward, as described above), and/or the like. In at least one arrangement, the anticipatory state may signal a user that user input and/or other action is about to be required.

In one or more arrangements, an on-beat state may include instructions defining one or more visual changes to be made to a glyph on a beat in an audio track being played. Such visual changes may include, for example, adding a red glow to the glyph, causing the glyph to pulse in size, and/or the like. In at least one arrangement, a success state may include instructions defining how a glyph should change when a user successfully synchronizes user input (e.g., a tap) with a beat in an audio track being played. Such a change may include a bloom, as further described above, in which the glyph may transform or morph into one or more other shapes (e.g., a sphere may bloom into a set of shooting stars). In at least one additional arrangement, a failure state may include instructions defining how a glyph should change when a user does not synchronize user input (e.g., a tap) with a beat in an audio track being played. Such a change may include changing the size and/or color of the glyph (e.g., darkening the color and/or texture of the glyph, shrinking the size of the glyph, etc.).

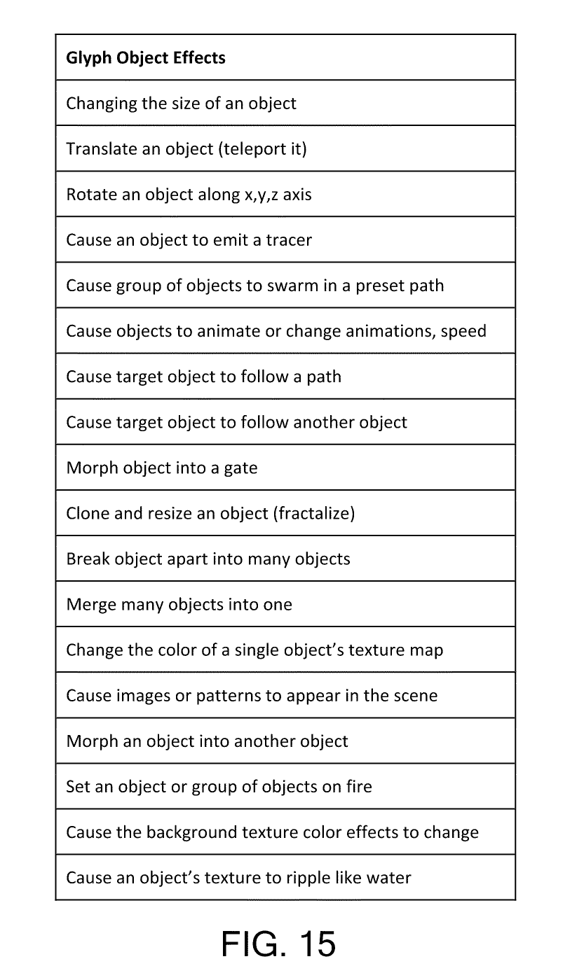

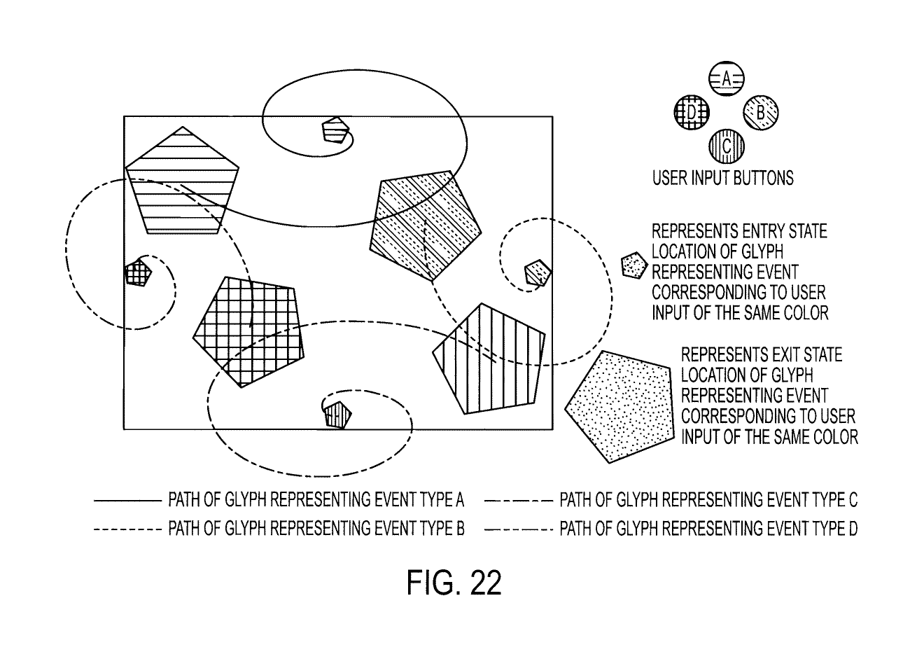

FIG. 22 illustrates an example set of glyph paths according to one or more aspects described herein. As may be seen in FIG. 22, different glyphs may be associated with different entry locations, exit locations, paths, and/or expected user input. In addition, various properties of a particular glyph, including its entry location, exit location, and/or path, may vary based on whether user input matches expected user input for the particular device (e.g., if a user inputs “A” for a glyph that has an expected user input property of “A,” the glyph's entry location, exit location, and/or path may be different from the glyph's entry location, exit location, and/or path in a situation where the user inputs other input not matching the expected user input property of the glyph). FIG. 15 illustrates an example listing of visual effects according to one or more aspects described herein, and one or more of these visual effects may be displayed as a particular glyph changes states and/or as user input is received.

According to one or more aspects, a scene may include one or more patterns. A pattern may be a glyph that includes a plurality of objects in a group and/or in a sequence. For instance, a pattern may represent several musical movements or notes in an audio track that are clustered together. In at least one arrangement, where a user is awarded points for synchronizing user input with one or more beats of an audio track, a user may be awarded extra points for synchronizing user input with all (or some) of the one or more beats associated with a pattern. Additionally or alternatively, such pattern matching may cause a visual reward to be displayed, and the visual reward may comprise at least one glyph that is larger and/or more dynamic than other glyphs typically included in the scene. Moreover, synchronizing user input with one or more beats associated with this reward glyph may result in still more extra points being awarded to the user. Additionally or alternatively, increasingly successful performance by the user during game play may cause the system to generate increasingly larger, more dynamic, and/or more detailed blooming objects on an associated display. For instance, as a user synchronizes user input with more and more beats of a pattern, the system may display increasingly larger, more dynamic, and more detailed blooming objects (e.g., where a sphere bursts into a cluster of stars, the stars may then morph and divide into other more detailed objects, which too may burst, morph, and/or divide into still more objects) to the user as a visual reward.

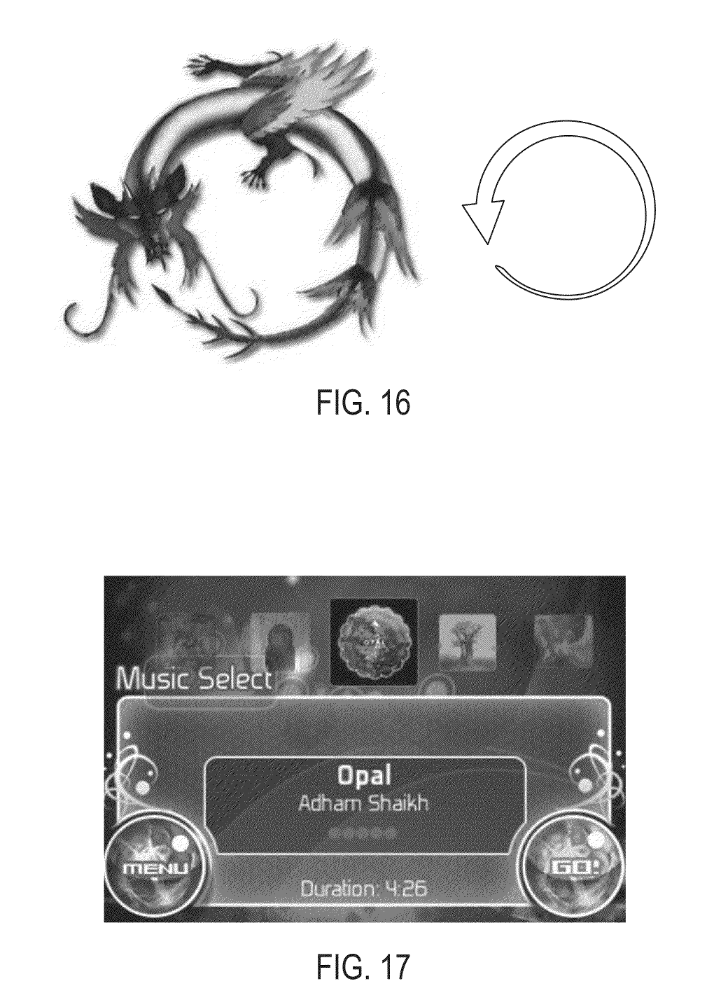

According to one or more additional aspects, life form objects may be similar to glyphs, but life form objects may represent longer musical events in an audio track than a glyph might. FIG. 16 illustrates an example life form object according to one or more aspects described herein. As may be seen in FIG. 16, a life form object may appear in a scene as an elaborate object, such as a creature like a dragon as in FIG. 16. Additionally or alternatively, a life form object may appear to be larger, more elongated, and/or have a visibly different path than other glyphs typically included in a scene. In at least one arrangement, a life form object also may be associated with a different type of expected user input than other glyphs typically included in a scene. For example, rather than tapping on a life form object at a beat of an audio track, a user might tap and hold a life form object at a beat (or during a plurality of beats) of an audio track. In other words, a user might trace the path of the life form object on the display at a particular beat or during a particular plurality of beats. In addition, where a user is awarded points for synchronizing user input with one or more beats of an audio track, a user may be awarded extra points for tracing the entire path of the life form object during the particular plurality of beats (e.g., the user may be awarded points in proportion to the amount of time that the user correctly traced the path of the life form object).

According to one or more aspects, the combination of glyphs, patterns, life form objects, and/or blooming objects that are displayed during game play may comprise the reward to a user for successful game play. In one or more arrangements, the creation of these various objects and/or other background effects may depend on subtle motions of the user captured as user input by one or more accelerometers and/or other motion sensors. In this way, the game play experience may be enhanced and/or may more closely mirror the user's activities and/or actions.

In one or more arrangements, in addition to generating glyphs (e.g., based on notes in an audio track being played), as described above, the glyph manager further may generate patterns and/or life form objects. In at least one arrangement, the glyph manager may generate such glyphs, patterns, and/or life form objects based on meta-data associated with one or more audio tracks. In this way, glyphs, patterns, and/or life form objects may aesthetically match the sound of one or more associated audio tracks. For instance, the glyph manager may determine the brightness and/or particle size of one or more glyphs, patterns, and/or life form objects based on loudness mapping. In another example, the glyph manager may determine the initial size of one or more glyphs, patterns, and/or life form objects based on attack mapping. In yet another example, the glyph manager may determine the maximum size of one or more glyphs, patterns, and/or life form objects based on sustain mapping. In still another example, the glyph manager may determine the drift distance and/or duration of one or more glyphs, patterns, and/or life form objects based on decay mapping. Of course, in some arrangements, the types of mapping corresponding to different properties may be varied (e.g., the maximum size of one or more glyphs, patterns, and/or life form objects may be determined based on decay mapping or attack mapping). In at least one arrangement, similar types of mapping may affect other aspects of game play (e.g., such mapping may be used to account for note timing in determining when and/or how anticipatory action indicators are displayed).

According to one or more aspects, the one or more audio tracks associated with game play may be of any genre of music. In at least one arrangement, the visual effects displayed during game play and/or the various mapping functions performed by the system (e.g., by the glyph manager) may be selected to match the genre and/or emotional nature of the one or more audio tracks (e.g., which may be active, dreamy, hypnotic, and/or of another emotional nature). Thus, in one or more arrangements, when a video game implementation of one or more aspects of the disclosure is provided to the user, such an implementation may include one or more audio tracks and pre-programmed scenes, as this may enhance the degree to which the visual effects displayed during game play and/or other game elements match the genre and/or emotional nature of the one or more audio tracks. Additionally or alternatively, a user may be able to import one or more audio tracks to be used in game play, and/or a user may be able to access and/or download one or more audio tracks to be used in game play from one or more network servers (e.g., one or more Internet servers hosting websites).

As described above, one or more aspects of the disclosure may be implemented in various hardware devices and/or components described herein. Additionally or alternatively, one or more aspects of the disclosure may be implemented in software that is compatible with a variety of platforms. For instance, an example implementation may comprise one or more motion sensors, an audio interface, a display, a processor and memory, and a network interface card. Examples of such devices, and examples of different platforms on which aspects of the disclosure may be implemented, include the NINTENDO Wii, the APPLE iPhone and/or iPod Touch, the SONY Playstation 3, the MICROSOFT XBOX 360, APPLE iOS, MICROSOFT Windows, APPLE Mac OS X, and LINUX. In another example, LINUX ARCADE software may be used in implementing aspects of the disclosure in a coin-operated arcade game.

According to one or more aspects, a physical interface and/or game controller may enable a user to engage in game play. In one or more arrangements, a commercially available controller or device may be used by a user in engaging in game play. For example, a user may use a MICROSOFT XBOX 360 controller or a NINTENDO Wii controller, and/or the user may use a device itself, such as an APPLE iPhone, as a controller. Additionally or alternatively, other devices and/or data capture technologies may be used in receiving user input. For instance, a video camera (such as a MICROSOFT XBOX Live video camera) may be used to sense a user's gestures and/or full-body postures. In another example, one or more dance pads, game microphones, drum game controllers, and/or guitar game controllers also may be used in receiving user input and/or in interacting with glyphs. In at least one arrangement, multiple controllers may be used in an implementation to enable more than one user to simultaneously engage in game play. In one or more additional arrangements, biosensing devices that measure electroencephalography (EEG), electromyography (EMG), electrocardiography (EKG), and/or galvanic skin response (GSR) may be used in monitoring and/or modeling a user's physical state, which may enable further interaction between the user and aspects of the disclosure. Additionally or alternatively, location-sensing components, such as one or more global positioning system (GPS) radios, may enable a user's location to be considered as user input in one or more aspects of the disclosure. Thus, a user's location may affect the way in which the user interacts with one or more aspects of game play, may allow a user to locate one or more nearby teammates and/or competitors, may allow a user to unlock new audio tracks and/or other content, and/or may measure a distance traveled by a user as a form of user input.

According to one or more aspects, a user may be able to select one or more audio tracks to be played during a game play mode. FIG. 17 illustrates an example user interface by which a user may select an audio track according to one or more aspects described herein. In one or more arrangements, a user may select an audio track from a listing of audio tracks or songs. Each of the audio tracks may be provided with the game play implementation, may be available for purchase (e.g., via a website accessible via the Internet), may be imported and/or designed by the user (e.g., using a visual music editor), and/or may be otherwise acquired. In at least one arrangement, displaying a song selection user interface may include displaying additional information about each of the one or more audio tracks, displaying a difficulty selection menu, and/or displaying one or more buttons via which a user may select an audio track or song and/or otherwise navigate one or more menus.

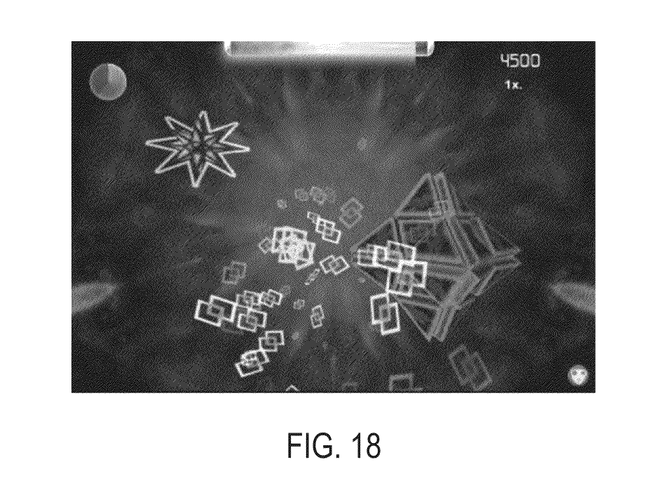

According to one or more aspects, subsequent to a user selecting a song and, in some instances, a difficulty level, an instance of a scene may be loaded, displayed, and/or initiated. FIG. 18 illustrates an example user interface including a plurality of glyphs and other objects in a scene according to one or more aspects described herein. In one or more arrangements, in loading, displaying, and/or initiating a scene, an environment also may be established, and this establishing may involve displaying a background and/or beginning to play one or more audio tracks.

In at least one arrangement, during a game play mode, a dynamic adaptation algorithm may control various aspects of game play, such as what object or objects may be displayed in the scene and/or in the environment, the duration for which a particular object or objects may be displayed, the speed at which a particular object or objects may move through the environment, the size of the timing window in which user input may be received, the size of the collision box in which user input may be received, and/or other aspects of game play. As described above, a user engaging in game play (e.g., watching and/or listening to a scene) may use a game controller and/or a touch-sensitive display to interact with one or more glyphs and/or other objects included in the scene. For instance, the scene (e.g., the example scene included in the user interface illustrated in FIG. 18) may include a glyph in an entry state, along with an associated anticipatory timing indicator, and/or another glyph in an on-beat state.

According to one or more aspects, when glyph beat matching occurs and/or when a user synchronizes user input with one or more beats of an audio track, the system may visually change the way in which the scene and/or other elements are displayed. For instance, the system may display a color shift effect, a blossoming and/or blooming effect, a teleportation to another level (e.g., a teleportation to a bonus level via a gate), and/or one or more other visual effects. In an arrangement where a user is awarded points for synchronizing user input with one or more beats of an audio track, the user's score or total number of points acquired may also be displayed in the user interface. In at least one arrangement, a user's creativity and/or improvisation may be scored as well, and this score also may be displayed in the user interface. Furthermore, the user interface may include one or more buttons to enable pausing, restarting, and/or ending the scene and/or game play activity, as well as one or more indicators to display a measure of the user's performance (e.g., an energy indicator) and/or to display a user's progress through a scene and/or game play activity (e.g., a time display).

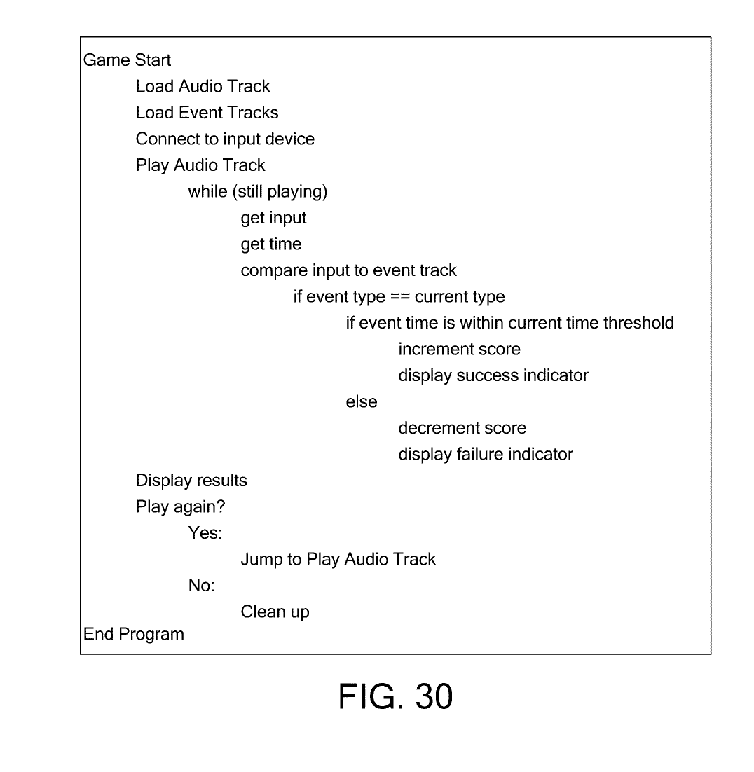

In one or more arrangements, at the conclusion of an audio track, the dynamic adaption algorithm may store information about the user, such as the user's final score and/or a difficulty value to be used in one or more future scenes and/or game play activities. FIG. 30 illustrates an example pseudocode sequence that may be used in implementing one or more aspects of the disclosure.

According to one or more aspects, the dynamic adaption algorithm may enhance game play and/or allow the system to provide a user with a customized experience that challenges the user and/or allows the user to remain in a state of flow. As the user becomes at better at synchronizing user input (e.g., with one or more beats of at least one audio track) and/or beat matching, the dynamic adaption algorithm may increase the difficulty level of the game play experience. Additionally or alternatively, where a user does not perform well in synchronizing user input (e.g., where a user fails to synchronize user input with one or more beats of at least one audio track) and/or beat matching, the dynamic adaption algorithm may decrease the difficulty level of the game play experience. In increasing and/or decreasing the difficulty level of the game play experience, the dynamic adaption algorithm may increase and/or decrease, respectively, the number of glyphs and/or other objects included in a scene, the speed of glyphs and/or other objects included in the scene, the length of the window of time in which synchronizing user input and/or beat matching may occur, the size of the tap region for synchronizing user input and/or beat matching, and/or the preciseness of movement required for successful game play.

In one or more arrangements, the system may present the user with more glyphs, objects, and/or other interaction choices and/or tasks than the user can actuate and/or accomplish at once. In this manner, the system may provide an expanded interaction space while allowing the user to choose to actuate and/or accomplish as many or as few glyphs, objects, interaction choices, and/or tasks as the user wishes. In at least one arrangement, the flexibility provided by the system may enable the user to engage in steering, which is a game play mode in which the system may adapt to user choices within a scene and/or an environment and subsequently continue presenting challenges to the user in a direction that is selected based on the user's choices. Additionally or alternatively, in one example, the system may enable multiple users to collaborate and/or compete in the accomplishment of various events and/or actions included in game play while playing on the same device or on different devices via a network connection. Furthermore, in this example, the dynamic adaption algorithm may account for the various activities engaged in by the multiple users.

According to one or more aspects, a system implementing one or more aspects of the disclosure may be implemented in many different embodiments, such as an online system for visual music creation, sharing, and/or play; an artistic performance system for use in live musical performances; and/or other forms.

In one or more arrangements, when implemented in an online system for visual music creation, sharing, and/or play, the system may enable a plurality of users to buy, design, create, and/or arrange scenes for audio tracks made by themselves and/or others. Additionally or alternatively, the system may enable one or more users to change existing scenes and/or audio tracks. In at least one arrangement, an audio track may be purchased online or recorded locally.

In one or more arrangements, prior to using an audio track in a game play mode, the system may analyze the audio track (e.g., using software like ECHO NEST, APPLE LOGIC STUDIO, ABLETON LIVE, and/or the like) and automatically generate meta-data that may be used in game play and/or further modified and/or expanded upon by the user. For example, a user may utilize a visual music editor to build a scene corresponding to an audio track, and the scene may include one or more glyphs, patterns, life form objects, and/or other objects and/or environmental aspects. For instance, a user may use the visual music editor to change the primary color of a selected scene from red to green. In addition, the user may customize the difficulty level of the scene. In at least one arrangement, the visual music editor may allow a user to upload the scene created by the user to a central server where other users may be able to download the scene and/or use the scene in game play. Additionally or alternatively, the visual music editor may implement drag-and-drop functionalities such that a user may drag and drop visual components (e.g., meta-data notes, glyphs, patterns, and/or other objects) onto a timeline or other display area corresponding to an audio track to associate such visual components with various parts of the audio track.

According to one or more aspects, the system may provide a user with network and/or data connectivity. Using such connectivity, a user may connect to a server and upload one or more audio tracks and/or related data. In at least one arrangement, a user may share one or more audio tracks and associated meta-data via one or more social networks, such as FACEBOOK, MYSPACE, and/or the like. Additionally or alternatively, a user may engage in game play in and/or via one or more of such social networks. In at least one additional arrangement, a user may engage in game play with other users via one or more various connections. For example, a user may engage in game play with one or more other FACEBOOK users by connecting to FACEBOOK. In another example, a user may engage in game play with one or more other users via a direct connection to devices utilized by such users (e.g., a universal serial bus connection, a serial port connection, an infrared connection, and/or the like) and/or via a network connection to such devices (e.g., an Internet connection, a wireless network connection, a client-server connection, a social networking application connection, and/or the like).

In one or more arrangements, the system may enable the user to engage in game play with one or more other users across different software platforms (e.g., APPLE IOS, FACEBOOK, NINTENDO WII, etc.). For example, a first user who is engaging in game play using an APPLE iPhone may be able to collaboratively and/or competitively engage in game play with a second user who is engaging in game play using a NINTENDO Wii.

According to one or more aspects, when implemented in a multiplayer arrangement, the system may allow users to collaborate and/or compete in various activities, such as the accomplishing of event actions. Each of the plurality of users involved in multiplayer game play may share as much or as little information with the other user or users as necessary and/or as they select in their respective privacy settings (e.g., a user may choose to share all of his or her input data, or a user may choose to share only his or her current score). In addition, the system may display to each of the users involved in multiplayer game play the status and/or progress of the other users (e.g., teammates, competitors, etc.). The amount of information about other users that is displayed may depend on the limits of each particular user's display device and/or one or more preference settings configured by each particular user.

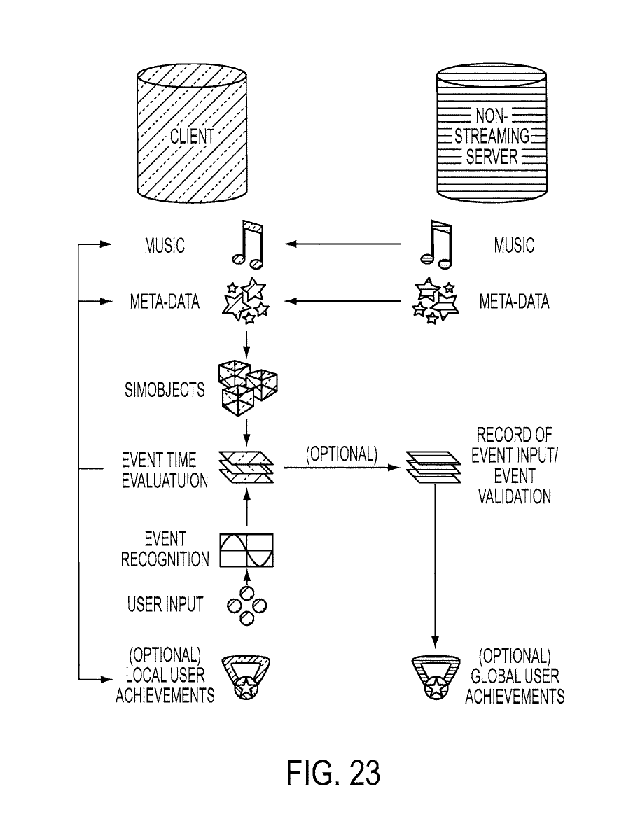

According to one or more aspects, various arrangements of the system may allow for single-user and/or multiplayer game play (e.g., peer-to-peer, clients and central server, etc.). For example, FIG. 23 illustrates an example single-user mode in which a user may download music and/or meta-data from a server, and the user thereafter may play the music and/or meta-data at his or her leisure. Subsequent to game play, information about the user and/or the user's score or scores may be uploaded to the server, and the server may rank the user against other users based on scores and/or other information.

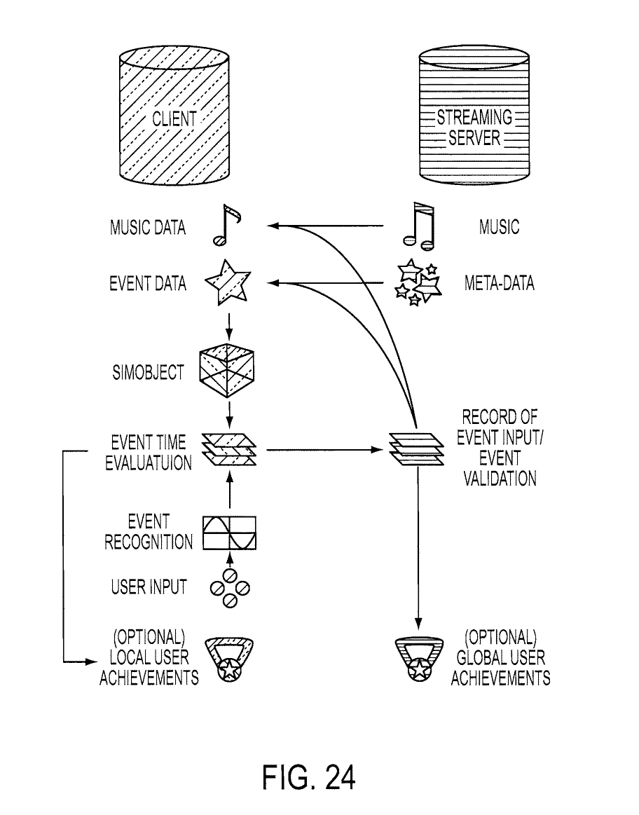

FIG. 24 illustrates an example single-user mode in which the system streams music and/or meta-data from a server to the user. In at least one arrangement, this mode may require that the user have a constant data connection while engaging in game play.

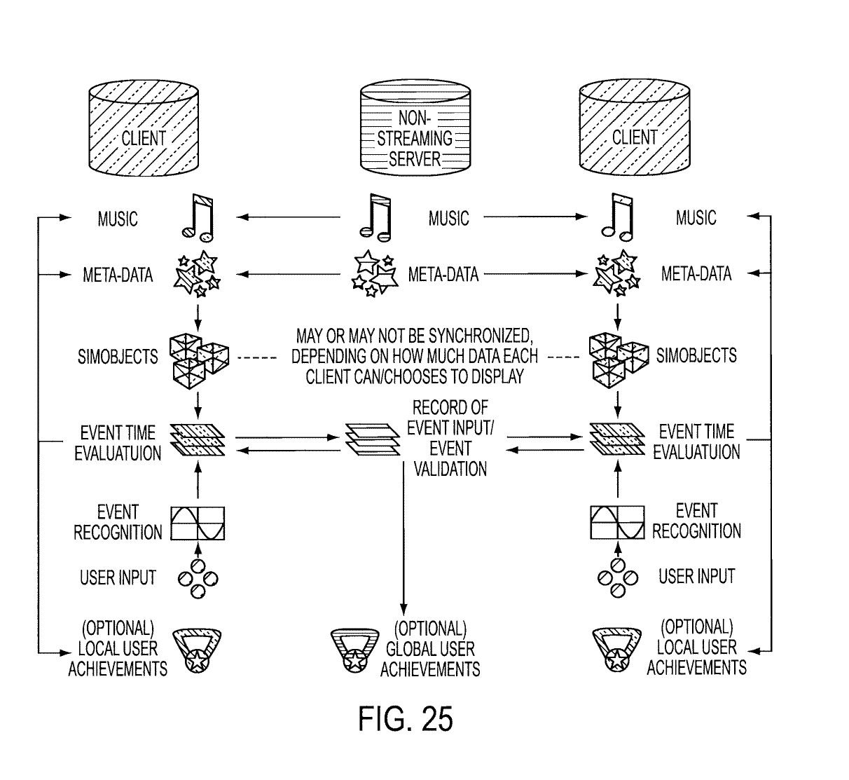

FIG. 25 illustrates an example multiplayer mode in which a server coordinates game play across multiple clients for multiple users. In this example, each user's device may store the music and/or meta-data needed for game play, thus, the server might not stream the music and/or meta-data to the users. Additionally or alternatively, this arrangement may allow the users to engage in game play at different times (while still playing competitively or collaboratively).

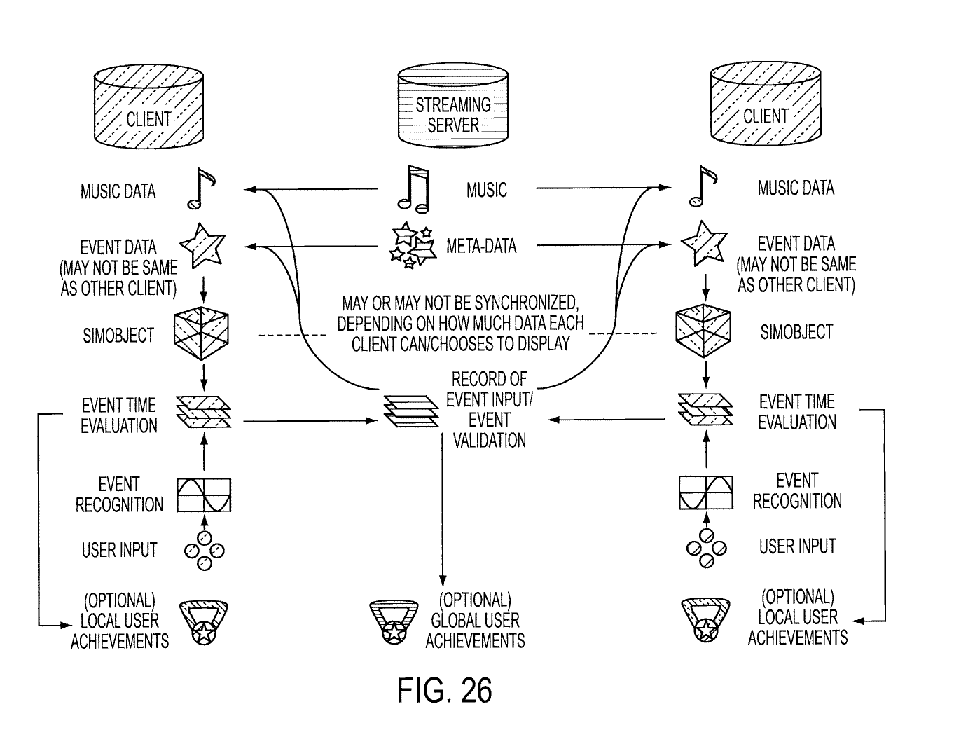

FIG. 26 illustrates an example multiplayer mode in which a server coordinates game play across multiple clients for multiple users and in which the server streams music and associated meta-data to each user.

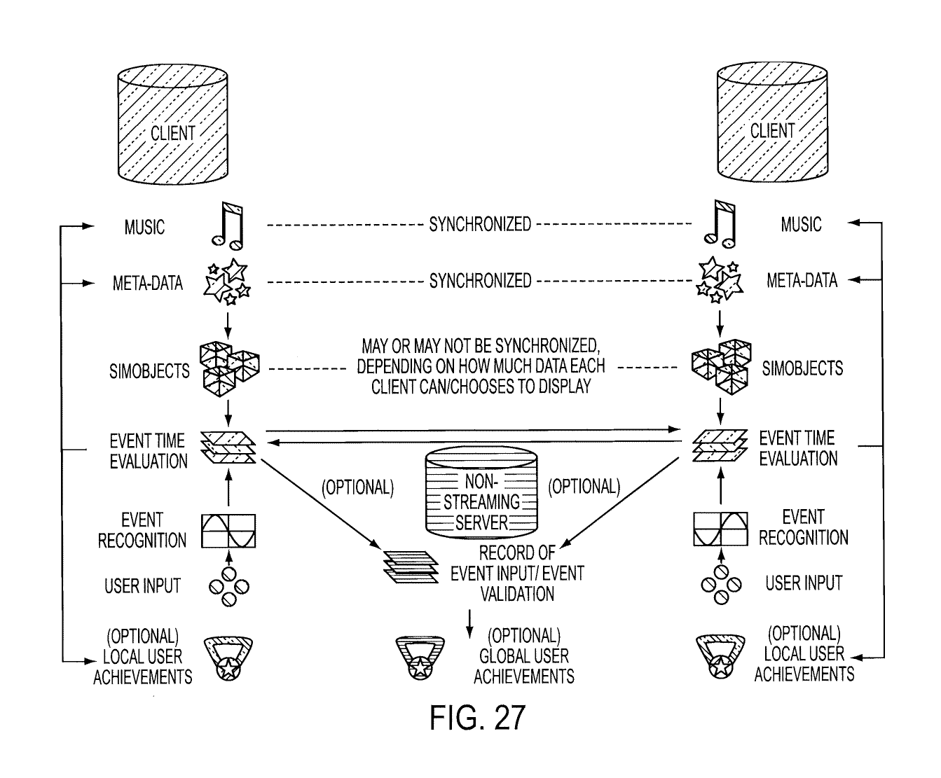

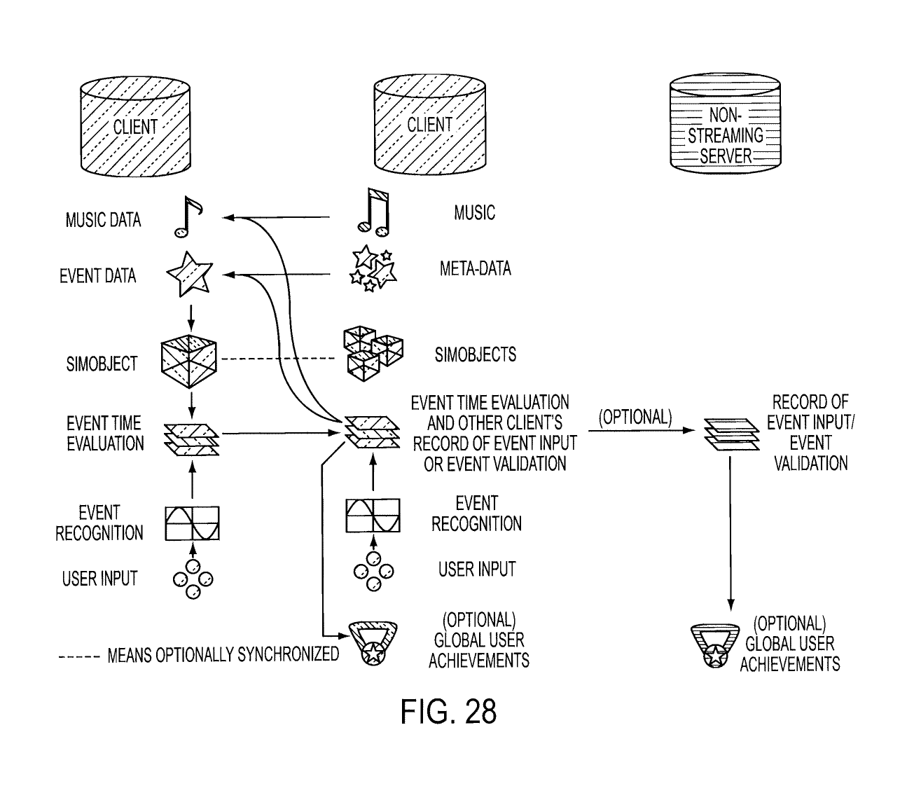

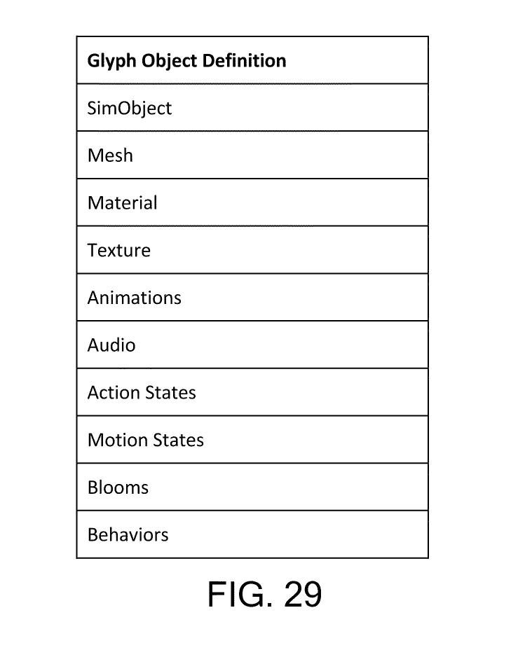

FIG. 27 illustrates an example peer-to-peer multiplayer mode in which the peers or users are equal. On the other hand, FIG. 28 illustrates an example peer-to-peer multiplayer mode in which the peers or users are not equal. In this second example, where the peers are not equal, one peer may act as a streaming server as well as a client, while the other peer might only act as a client. The situation in this second example may arise, for instance, where a first user is using a more powerful device, such as a SONY PLAYSTATION 3 or a NINTENDO WII, while a second user is using a less powerful device, such as an APPLE IPHONE or other smart phone.

According to one or more aspects, one or more of the methods described herein also may be implemented in a variety of systems providing music-related interactive experiences. Such implementations may adapt any kind of traditional game play mechanics (e.g., side-scrolling games, racing games, fighting games, etc.) for a music-oriented action-response game play experience.

In one or more arrangements, when implemented in an artistic performance system for use in live musical performances, the system may allow a user to act as a performance artist and create their own scene for game play. For example, a user may be able to manipulate a game controller and/or otherwise provide user input to the system in time with an audio track, and the system may process such user input and accordingly create one or more glyphs, patterns, life form objects, and/or other objects to accompany the audio track. At the conclusion of the audio track, the data created by the system may be saved, edited, and/or replayed in the online system described above, for instance, which further may allow the user to modify and/or rearrange different components of the scene.

In at least one additional arrangement, the scene corresponding to the audio track and/or the meta-data may be viewed non-interactively as a passive artistic entertainment application, such as part of a visualizer function in a music program such as APPLE iTunes or MICROSOFT Windows Media Player.

In one or more additional arrangements, aspects of the disclosure may be implemented in a fitness scenario in which the physical action of interacting with the system may cause one or more users to lose weight and/or gain strength and/or flexibility. In another example, aspects of the disclosure may be implemented in a music education scenario in which a user may learn one or more musical patterns from the system and thereby acquire a deeper and/or more immediate understanding of musical theory. In another example, aspects of the disclosure may be implemented in a therapy and/or meditation application in which game play and/or the dynamic adaptation algorithm may enable a user to achieve a state of healing flow. Additionally or alternatively, aspects of the disclosure may be embedded in interactive and/or non-interactive audiovisual systems, such as screen savers, visualizers, music videos, movies, and/or other forms of visual entertainment, in a variety of devices and/or media, such as mobile devices, digital video discs, and/or the like.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects, such as one or more processors and/or one or more memories storing computer-executable instructions. Any and/or all of the method steps described herein may be embodied in computer-executable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method, comprising:
displaying a first moving object on a touch-sensitive display, the first moving object moving along a non-linear path;
changing a first display characteristic of the moving object synchronously with a beat of an audio track being played;
in response to receiving user input corresponding to a tap on the first moving object that is synchronized with the beat, altering the moving object in a first manner; and
in response to receiving user input corresponding to a tap on the first moving object that is not synchronized with the beat, altering the moving object in a second manner different from the first manner.

2. The method of claim 1, wherein altering the moving object in a first manner includes displaying a blooming object on the touch-sensitive display in place of the first moving object.

3. The method of claim 2, wherein the blooming object includes a plurality of moving objects, each of the plurality of moving objects growing in size over time.

4. The method of claim 1, wherein altering the moving object in a second manner includes removing the moving object from the display.

5. The method of claim 1, further comprising:
prior to changing the first display characteristic of the moving object, changing a second display characteristic of the moving object to signal a user of the approaching beat.

6. The method of claim 5, wherein changing the second display characteristic includes rendering a second moving object concentrically around the first moving object.

7. The method of claim 6, wherein the second moving object shrinks around the first moving object as the beat approaches.

8. One or more non-transitory computer-readable media having computer-executable instructions stored thereon that, when executed by at least one processor, cause the at least one processor to:
display a first moving object on a touch-sensitive display, the first moving object moving along a non-linear path;
change a first display characteristic of the moving object synchronously with a beat of an audio track being played;
receive user input corresponding to a tap on the first moving object;
determine whether the received user input is synchronized with the beat;
alter the moving object in a first manner when the received user input is synchronized with the beat; and
alter the moving object in a second manner different from the first manner when the received user input is not synchronized with the beat.

9. The one or more non-transitory computer-readable media of claim 8, wherein altering the moving object in a first manner includes displaying a blooming object on the touch-sensitive display in place of the first moving object.

10. The one or more non-transitory computer-readable media of claim 9, wherein the blooming object includes a plurality of moving objects, each of the plurality of moving objects growing in size over time.

11. The one or more non-transitory computer-readable media of claim 8, wherein altering the moving object in a second manner includes removing the moving object from the display.

12. The one or more non-transitory computer-readable media of claim 8 having additional computer-executable instructions stored thereon that, when executed by the at least one processor, further cause the at least one processor to:
prior to changing the first display characteristic of the moving object, change a second display characteristic of the moving object to signal a user of the approaching beat.

13. The one or more non-transitory computer-readable media of claim 12, wherein changing the second display characteristic includes rendering a second moving object concentrically around the first moving object.

14. The one or more non-transitory computer-readable media of claim 13, wherein the second moving object shrinks around the first moving object as the beat approaches.

15. One or more non-transitory computer-readable media having computer-executable instructions stored thereon that, when executed by at least one processor, cause the at least one processor to:
identify sound events in an audio track selected by a user;
receive a selection of a game play mechanic from a plurality of game play mechanics; and
generate a plurality of prompts based on the identified sound events and on the selected game play mechanic, each prompt prompting the user to provide user input synchronized with the identified sound events.

16. The one or more non-transitory computer-readable media of claim 15, wherein the selected game play mechanic is a side scroller game play mechanic.

17. The one or more non-transitory computer-readable media of claim 16, wherein at least one prompt prompts the user to provide user input representing a jump command synchronized with an identified sound event.

18. The one or more non-transitory computer-readable media of claim 15, wherein the selected game play mechanic is a fighting game play mechanic.

19. The one or more non-transitory computer-readable media of claim 15, wherein the selected game play mechanic is a racing game play mechanic.

20. The one or more non-transitory computer-readable media of claim 15, wherein the selected game play mechanic is an exercise game play mechanic.
